(19) United States
(12) Patent Application Publication
(10) Pub. No.: US 2009/0298718 A1
(43) Pub. Date: Dec. 3, 2009

(54) METHOD AND DEVICE FOR FORMING AN ASSEMBLY

(76) Inventors: Paul Winfield Denman, Minnetonka, MN (US); Jonathan D. Anderson, Chanhassen, MN (US); Sven Gustafson, Minneapolis, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/340,673

(22) Filed: Dec. 20, 2008

Related U.S. Application Data
(60) Provisional application No. 61/016,113, filed on Dec. 21, 2007.

(51) Int. Cl. C40B 60/00; B29C 45/14; B01L 3/00

(52) U.S. Cl. 506/33; 264/273; 422/102

(57) ABSTRACT

Methods and devices for producing an assembly, and the thus produced assembly, are provided. The assembly may be used in screening applications. In various embodiments, the assembly may comprise a first portion and a second portion. The first portion and second portion may be co-formed or may be separately formed. The assembly may be formed as a blank or may be formed with wells therein. The assembly may be further processed, for example via thermal processing, to form or modify wells in the assembly. In some embodiments, wells in the assembly may have custom volumes, custom shapes, or be arranged in a custom pattern.

### CROSS-REFERENCE TO RELATED APPLICATIONS

This application claims benefit of U.S. Provisional Application No. 61/016,113 filed Dec. 21, 2007.

### FIELD

A method and device for producing an assembly, and the assembly thus produced, are provided. More specifically, a method, device, design, and materials for producing a microplate assembly wherein the method and device enable customized shaping of wells, surface features, thermal properties, and optical properties of the microplate assembly, either at a supplier facility or at a consumer facility, and the assembly thus produced, are provided.

### BACKGROUND

Laboratory automation often involves conducting experiments using plates having multiple wells. These plates are known as “microplates,” “multi-well sample plates,” or “microtitre plates.” A typical microplate is formed of one or more materials and has an array of wells, sometimes referred to as sample wells. The microplate wells are used to hold specimens to be tested in a laboratory experiment or may hold samples for storage or are used to collect samples. In specific applications, the wells are used to store and mix compounds and biological samples for screening.

One area in which microplates are frequently used is in polymerase chain reaction (PCR) process. PCR processes are associated with replicating genetic material such as DNA and RNA and are typically carried out on a large scale in both industry and academia. Because they are relatively easy to handle and low in cost, microplates are often used during the PCR process.

In accordance with the PCR process, a small quantity of genetic material and a solution of reactants are deposited within each well of the microplate. The microplate is then placed in a thermocycler that cycles the temperature of the contents within the wells. Specifically, a heating fixture in the thermo-cycler repeatedly heated and cooled, for example, for application of the DNA. Another method is to move the microplate through differing temperatures of water baths.

Currently available microplates generally comprise a unitary polymer upper plate and a unitary polymer lower plate. The two plates are typically joined together mechanically. In this construction, the upper plate defines the side walls of the individual sample wells, and the lower plate defines the bottom walls of these wells. The upper plate is impervious to light, being either pigmented, or transparent but provided with an opaque coating at least on the side walls. The lower plate may be transparent for assays requiring light transmission or may be opaque for the assays involving emission monitoring. In this second case the lower plate may be made opaque through pigmentation or opaque coatings.

Microplates may alternatively comprise a unitary structure such as a single molding with opaque side walls and opaque bottom.

It is common in the art to manufacture microplates by molding the portion of the plate comprising the wells, for example the upper plate in a two-plate construction or the single molding in a unitary construction. Molding may comprise injection molding The tooling involved in an injection molding process can be extremely expensive. Accordingly, custom well shapes and sizes are generally avoided.

The needs of laboratories regarding the equipment, including microplates, however, are not uniform. Current options are generally limited to one well or many wells per frame. The tests or assays performed using the microplates provide critical information as to the effects of the compound to the reaction being tested. Laboratories using microplates perform specific tests to study and scan reactions for specific characteristics. These scans are related to the volume of chemistry in the well of the micro-plate. In some applications a laboratory may be forced to use higher volumes of product simply because of the size of the wells. Further, greater volumes may also be used with laboratory automation aspiration and dispensing systems because of the greater distance from the top of the plate to the bottom of the well. A smaller well volume could enable reduced product, such as that of expensive chemistries, usage and, as a result, cost savings. An additional advantage of a smaller well is that the microplate may be designed with a surface well that is shallower and closer to the top of the plate such that contents placed in the well are closer to the scanning or reading device, thus providing a better signal and more reliable scanned data. Custom well shapes could be useful in applications where a specific chemistry must be mixed, scanned optically, or retained in the well for special laboratory processes. Accordingly, the ability to rapidly customize well volumes and well dimensions would be useful, especially if such customization may be done at either a manufacturer facility or at a consumer facility.

It would be useful to provide a method and device for forming microplates that may be used to cost effectively produce microplates having custom well volumes, shapes, and sizes without the costly creation of new molding tools or modification of injection molding tools for each well shape and volume change.

### BRIEF SUMMARY

Methods for forming an assembly such as a microplate are provided. More specifically, a method for forming an assembly, the assembly comprising a first portion or material and/or a second portion and/or material, are provided. One or more wells may be formed in the microplate. The microplate assembly thus formed is further provided. The wells may have custom volumes, shapes, and sizes. For example, the wells may have volumes ranging from approximately 0.1 nanoliters to approximately 100 microliters.

In accordance with one embodiment, the method comprises forming a first portion and a second portion using two-shot molding. The first portion and the second portion may be formed using two-shot rotary molding or using two-material overmolding in either an automated or manual fashion.

In accordance with one embodiment, the method comprises molding a first portion using a primary material and molding a second portion using a secondary material. Molding of the second portion may be done through the first portion and may comprise directing the secondary material upwardly such that the second portion is molded from top to bottom. The microplate thus formed may be molded with specific well volumes in the molding factory or molded with a design, including a blank design, enabling it to be thermally formed later within the distribution or at the customer location, using thermal forming machines.

In accordance with one embodiment, the method comprises forming a single material or portion using one-shot molding. The single material may be formed in a one shot molding process. This single material can be molded with specific well volumes in the molding factory or molded with a design, including a blank design, enabling it to be thermally formed later within the distribution or at the customer location with thermal forming machines.

In accordance with another embodiment, the method comprises providing a first portion and a second portion and assembling the first portion and the second portion to form a plate. The second portion is preheated and the second portion is treated to form or modify wells therein.

In accordance with a further embodiment, a mircoplate assembly is provided. The assembly may comprise a first portion comprising a primary material and a second portion comprising a secondary material. The primary material may comprise a material that remains substantially rigid after thermal cycling. The secondary material may comprise a material suitable for thermal forming. The second portion may substantially overlay the first portion. The microplate assembly may further include an additional secondary material underlying at least a portion for the first portion to equalize possible shrinkage of the second portion. The first portion, the second portion, and the additional secondary material may be co-formed.

In accordance with yet another embodiment, a microplate assembly is provided. The microplate assembly comprises a first portion and a second portion. The first portion comprises a material that remains substantially rigid during and after PCR or related thermal cycling. The second portion comprises a material suitable for forming custom well shapes and volumes. One or more wells are formed in the second portion. The second portion substantially overlays the first portion.

In accordance with yet a further embodiment, a microplate assembly is provided having a first portion comprising a polycarbonate material, a second portion comprising a polypropylene material, and a sub-portion comprising polypropylene material. The second portion may comprise an array of wells, each well having a volume of approximately 2 microliters. The sub-portion underlies at least a portion of the first portion and equalizes possibly shrinkage of the second portion. The first portion and the sub-portion may form a matrix. The first portion, second portion, and sub-portion may be co-formed.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

### BRIEF DESCRIPTION

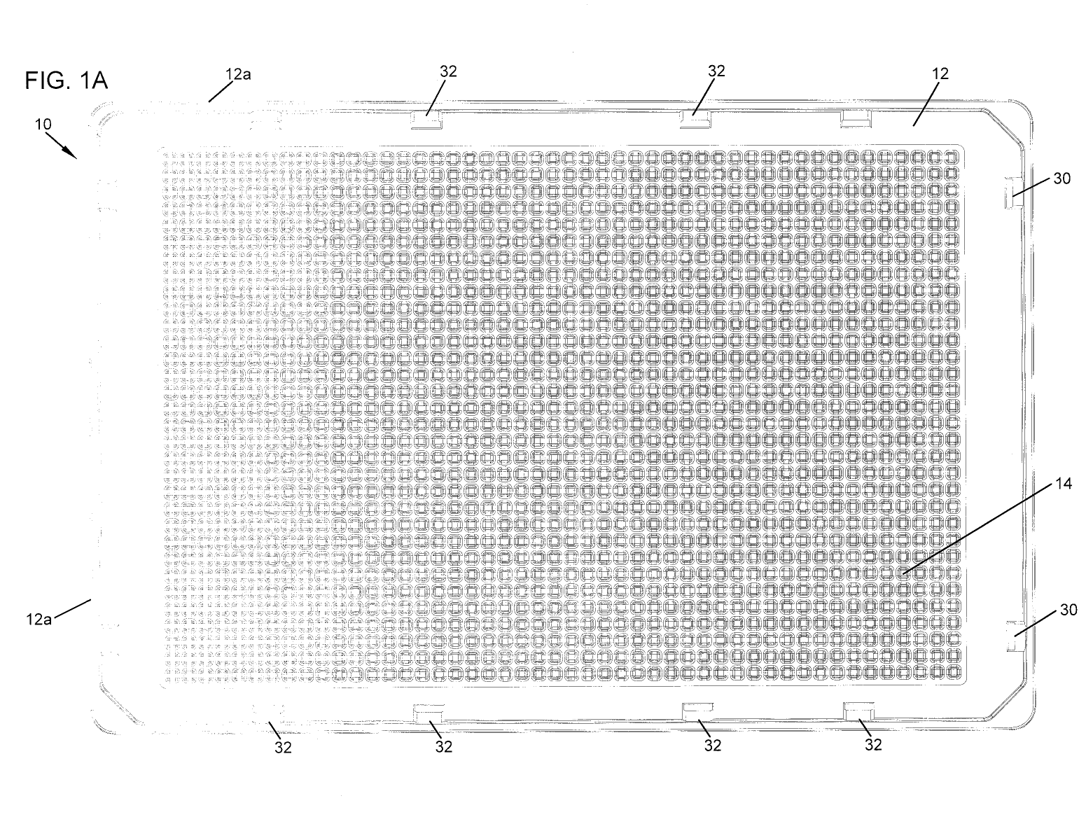

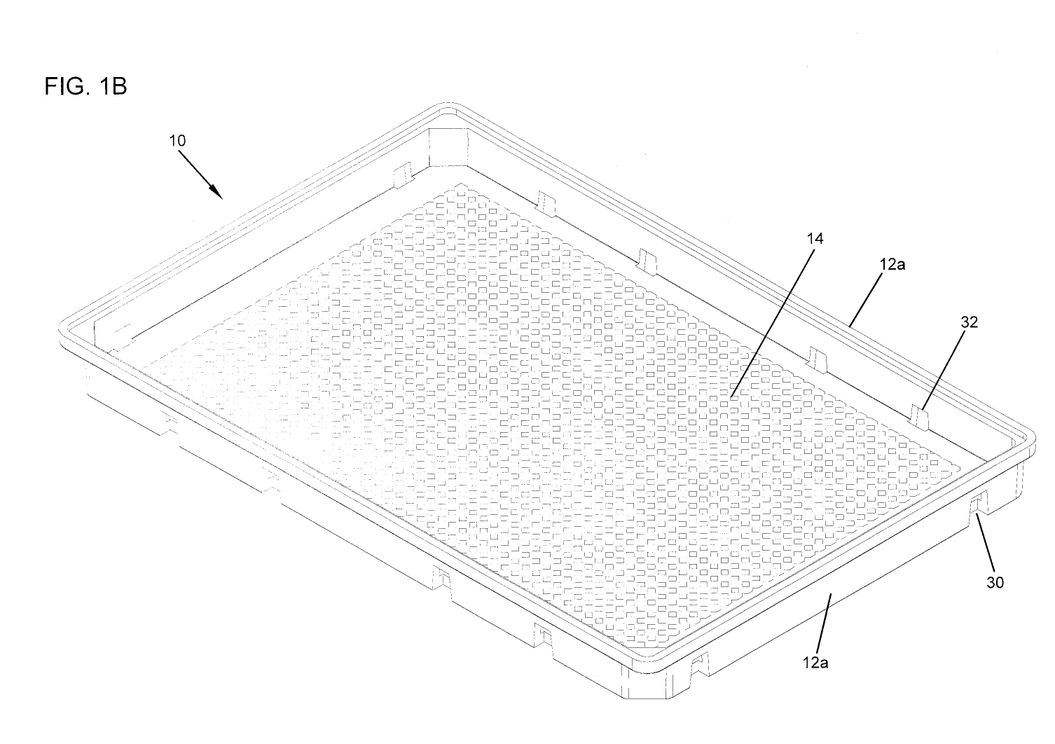

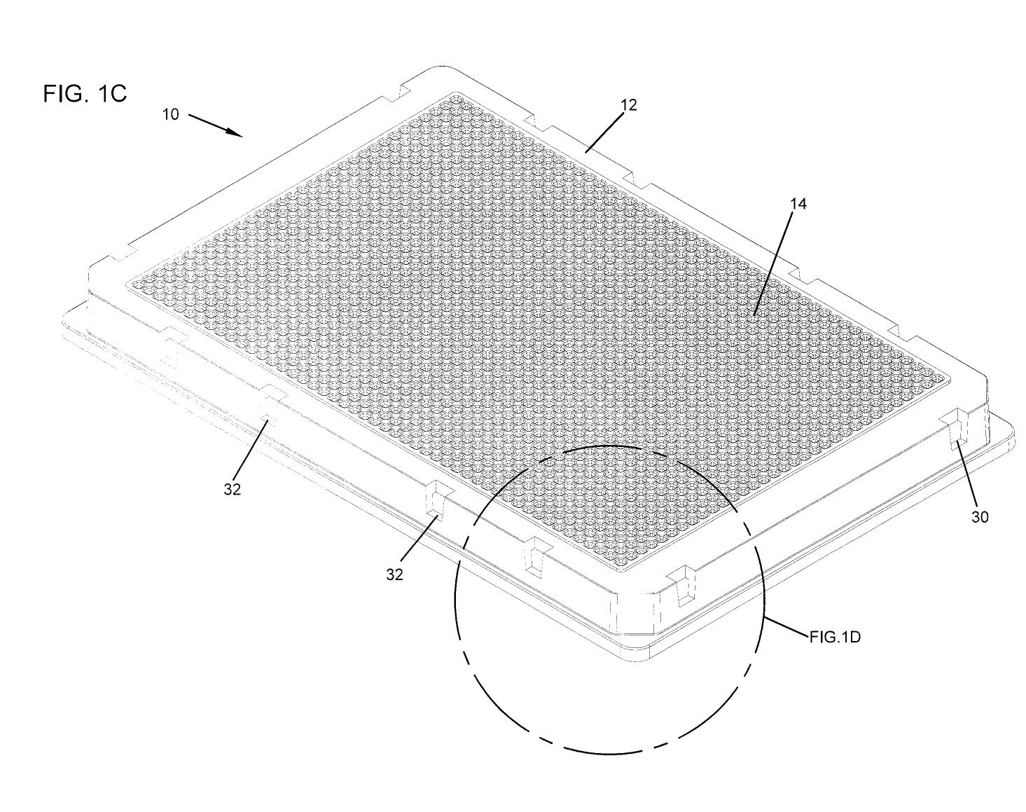

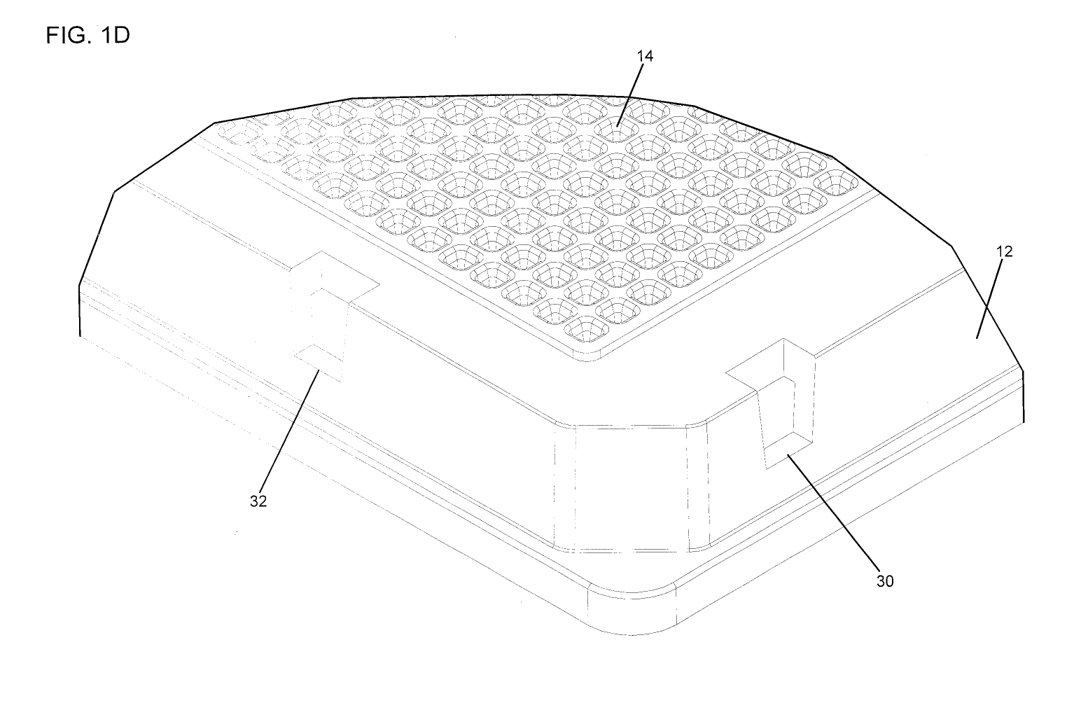

FIG. 1a illustrates a top view microplate in accordance with one embodiment.

FIG. 1b illustrates a bottom perspective view of the microplate of FIG. 1a.

FIG. 1c illustrates a top perspective view of the microplate of FIG. 1a.

FIG. 1d illustrates a detailed view of a corner of the microplate of FIG. 1a.

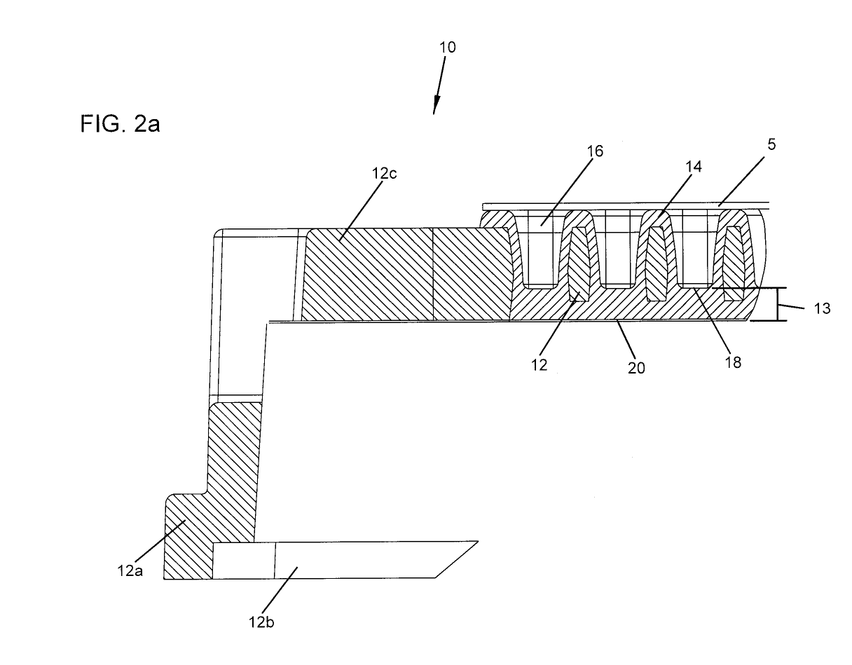

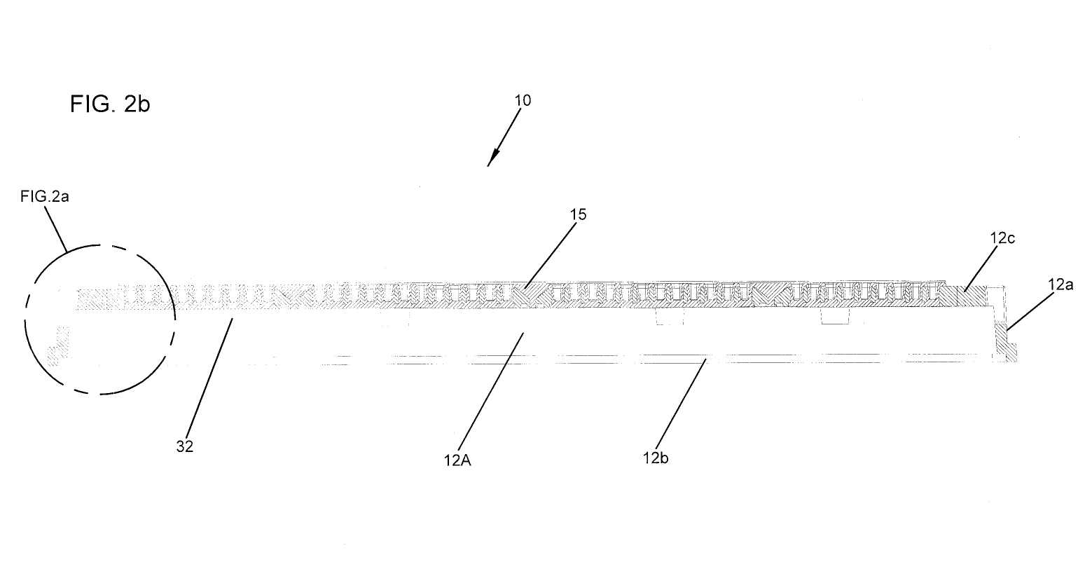

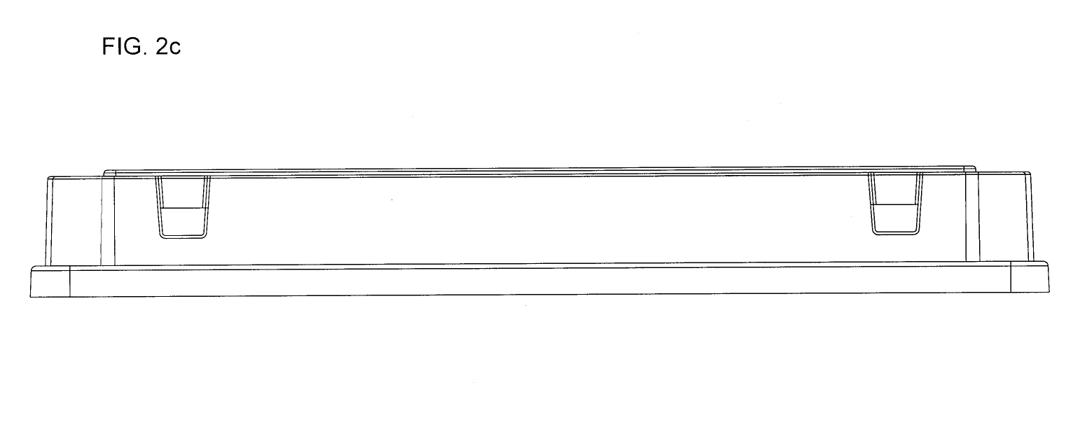

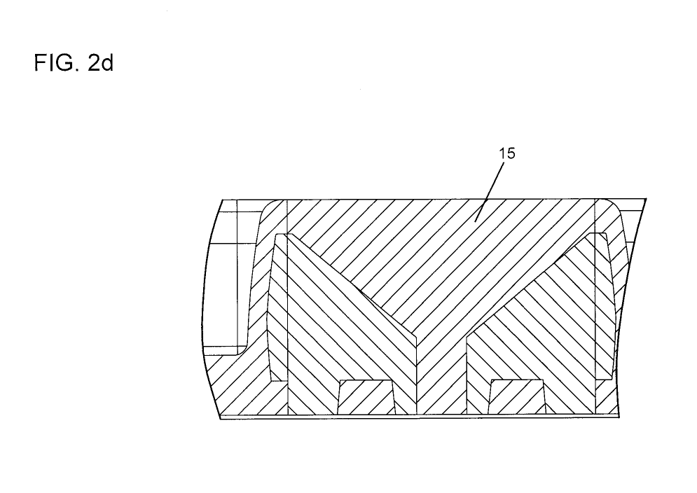

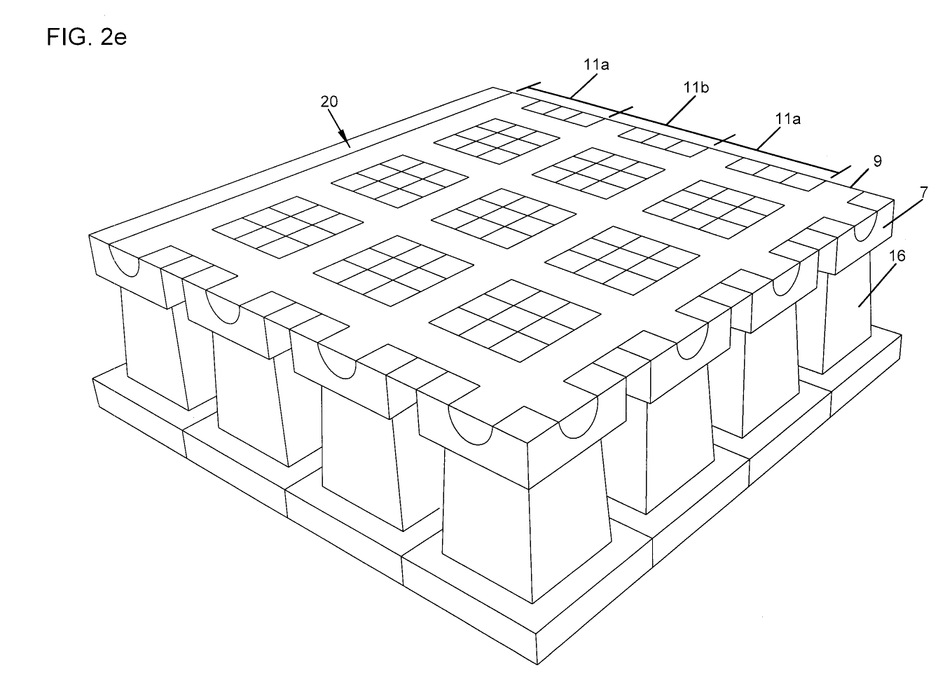

FIG. 2a illustrates a detailed side view of the microplate of FIG. 1a.

FIG. 2b illustrates a side view of the microplate of FIG. 1a.

FIG. 2c illustrates an end view of the microplate of FIG. 1a.

FIG. 2d illustrates a side view of a chamfer of the microplate of FIG. 1a.

FIG. 2e illustrates a detailed bottom perspective view of the microplate of FIG. 1a.

FIG. 3 illustrates a top perspective view of a plurality of wells in accordance with one embodiment.

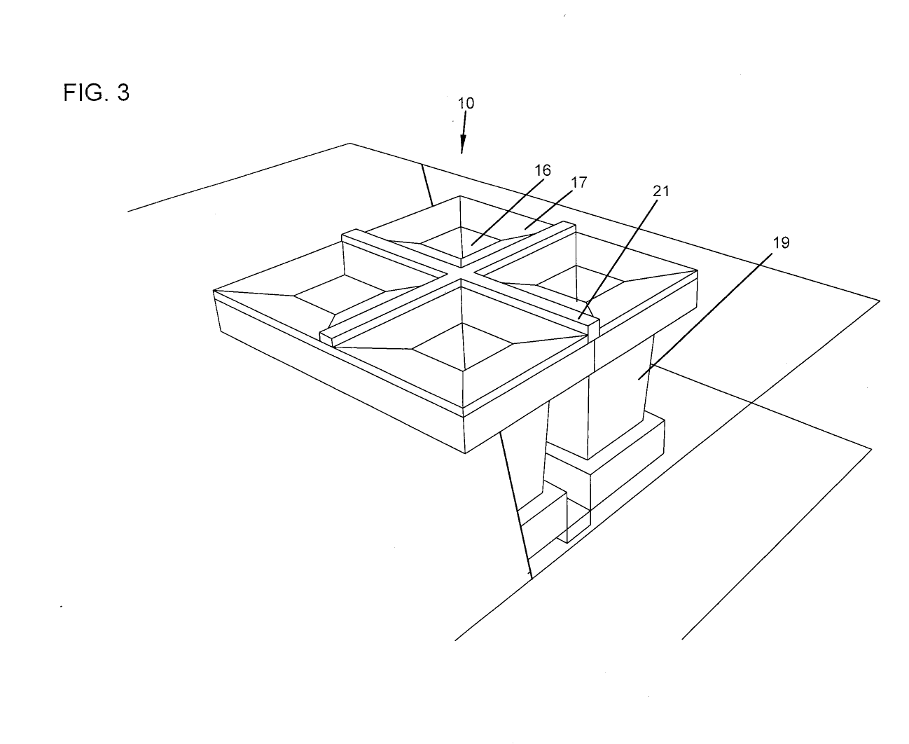

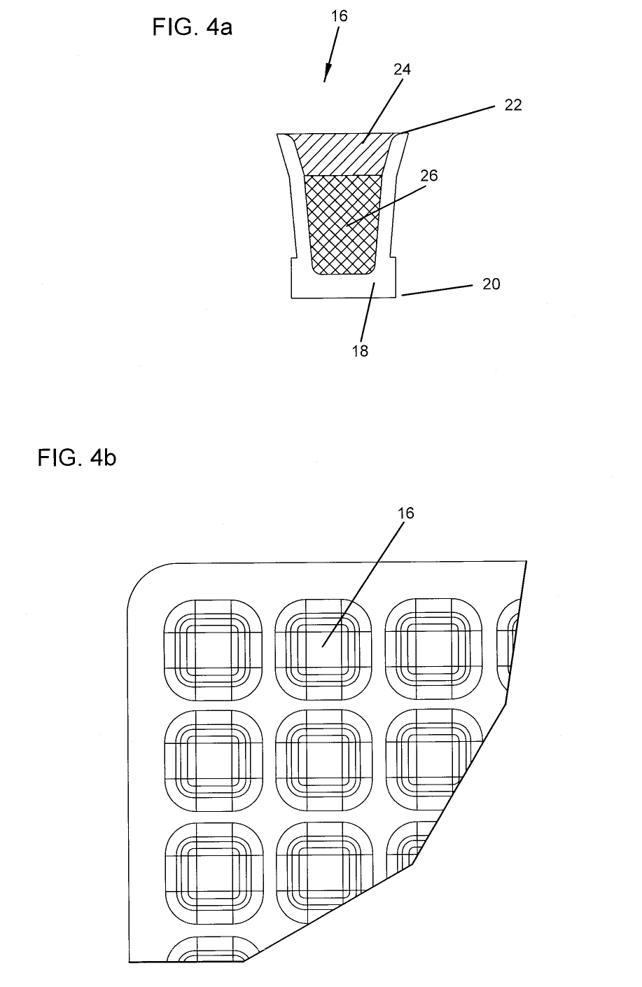

FIG. 4a illustrates a side view of a well in accordance with one embodiment.

FIG. 4b illustrates a top partial view of an array of wells in accordance with one embodiment.

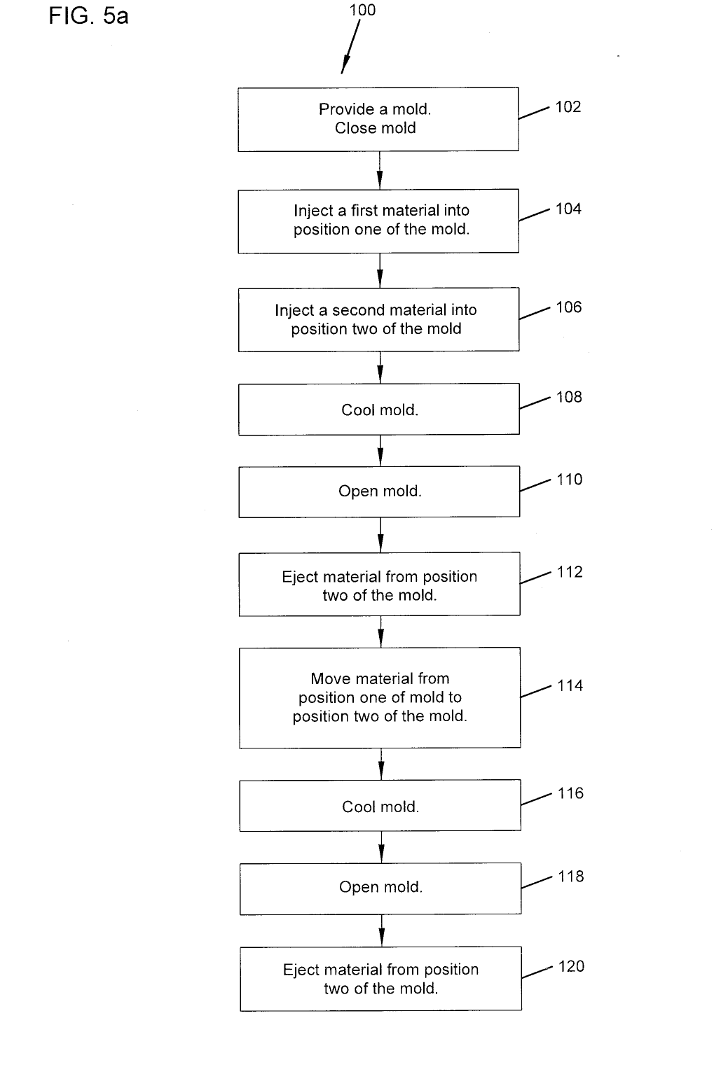

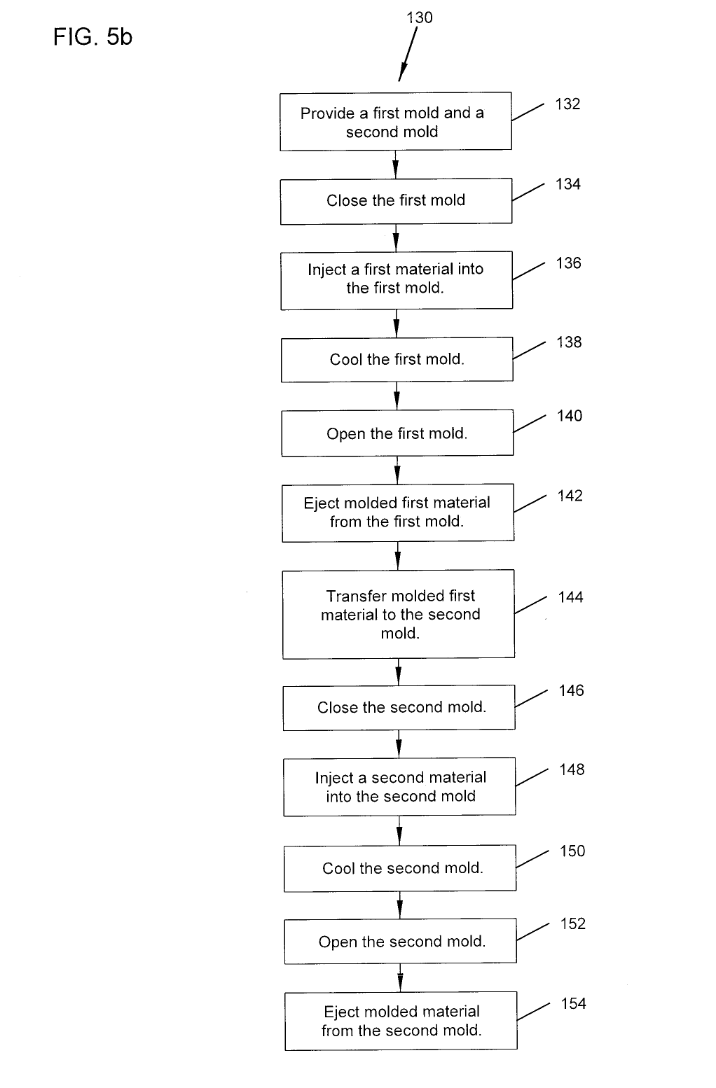

FIG. 5a illustrates a block diagram of a method for forming a microplate in accordance with one embodiment.

FIG. 5b illustrates a block diagram of a method of forming a microplate in accordance with another embodiment.

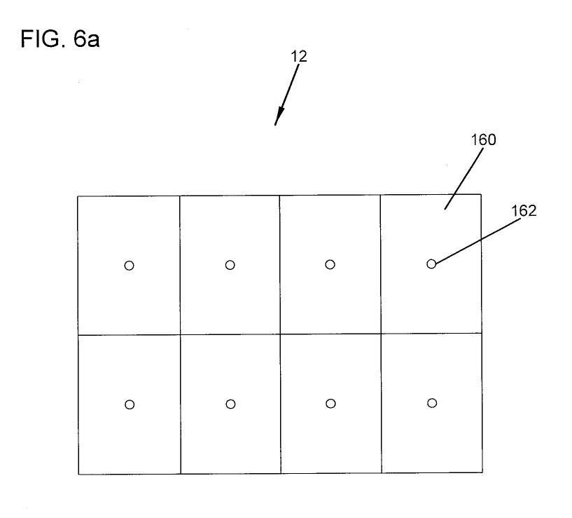

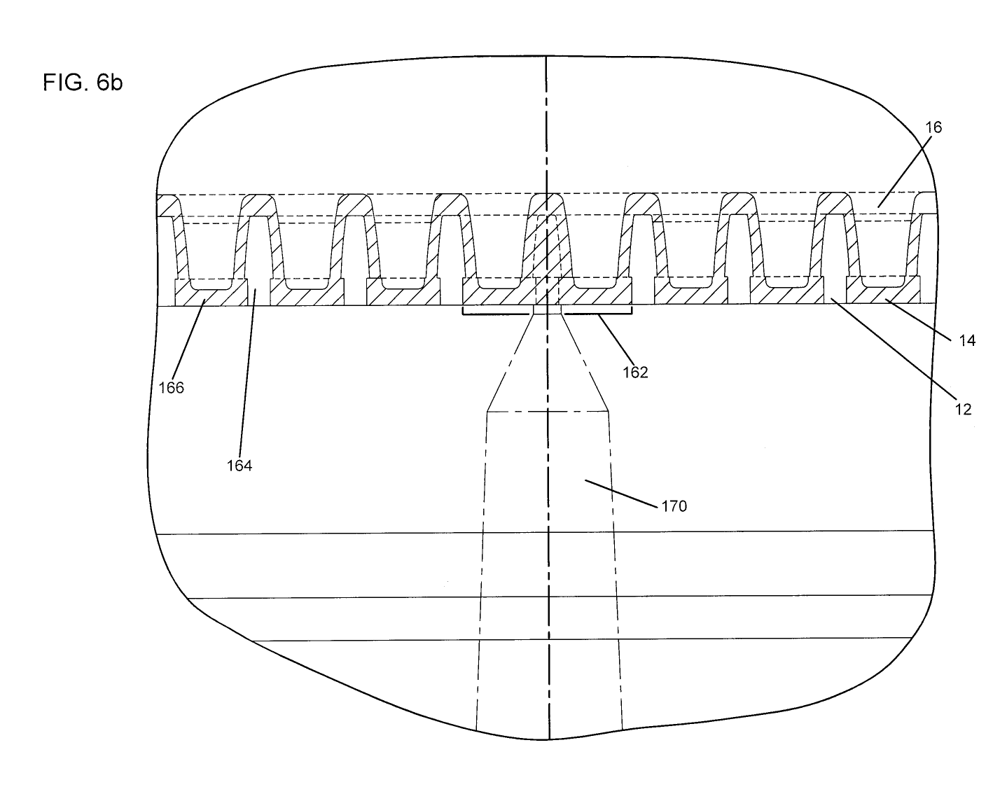

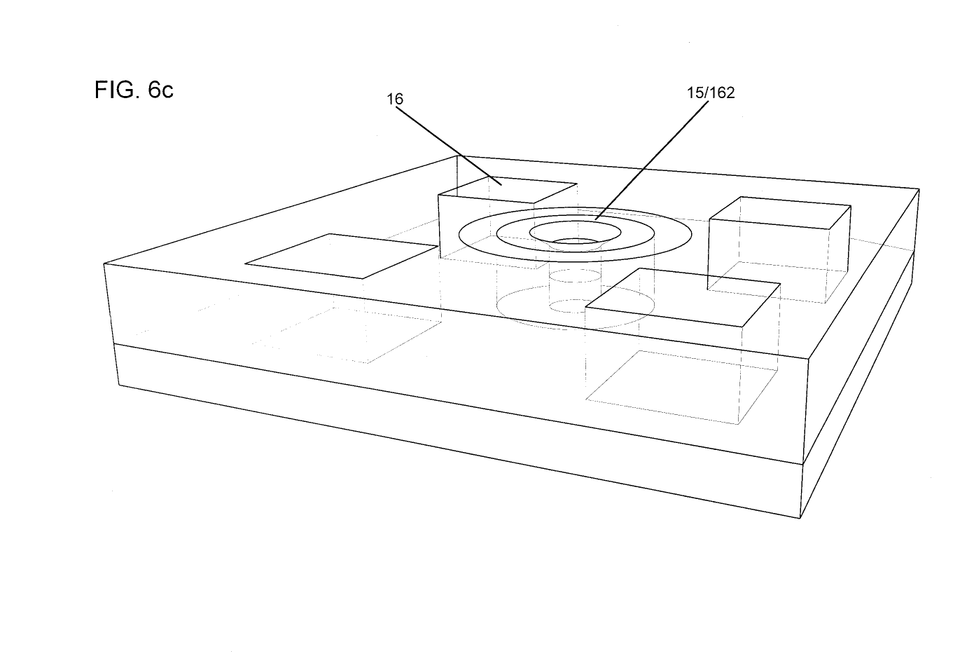

FIG. 6a illustrates a top view first portion of a microplate prior to injection of a second shot during formation of a microplate in accordance with one embodiment.

FIG. 6b illustrates partial side view of injection of a second shot through a first portion during formation of a microplate in accordance with one embodiment.

FIG. 6c illustrates a top perspective view of a microplate portion including wells and a chamfer in accordance with one embodiment.

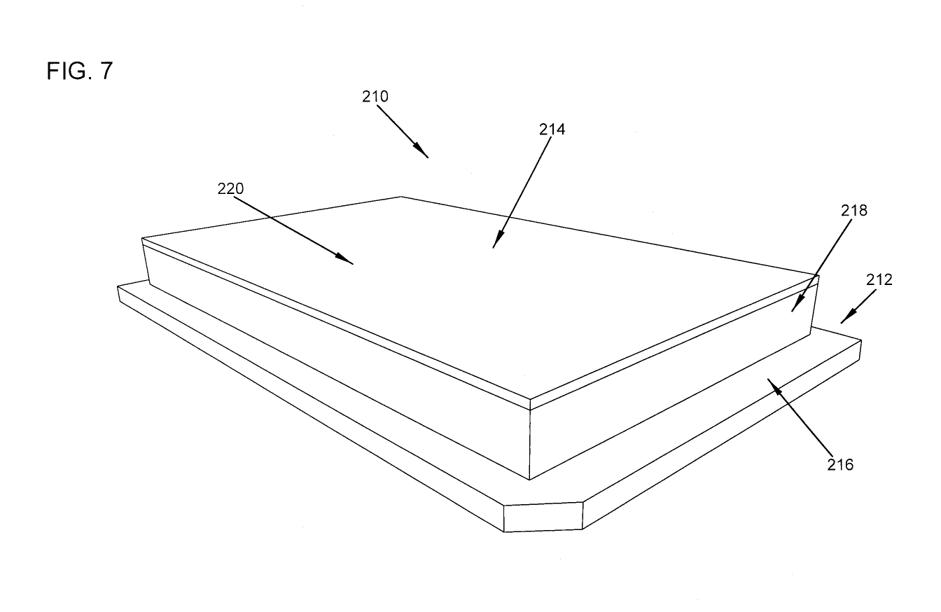

FIG. 7 illustrates a top perspective view of a blank comprising a first portion and a second portion in accordance with one embodiment.

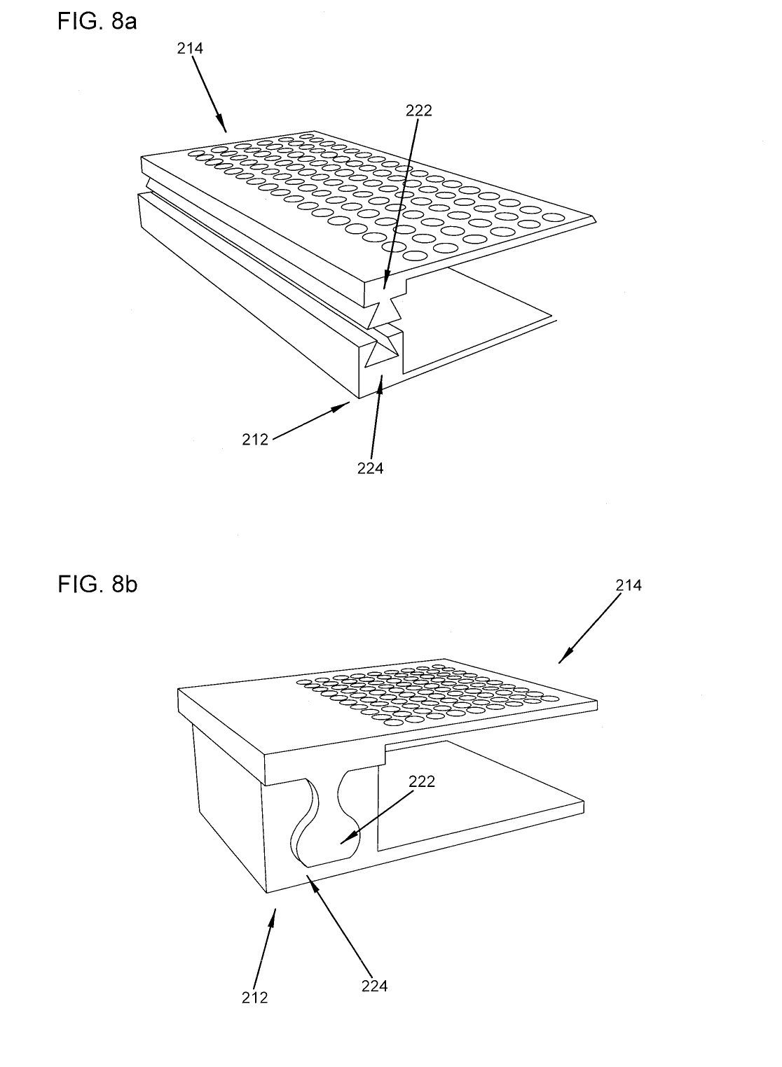

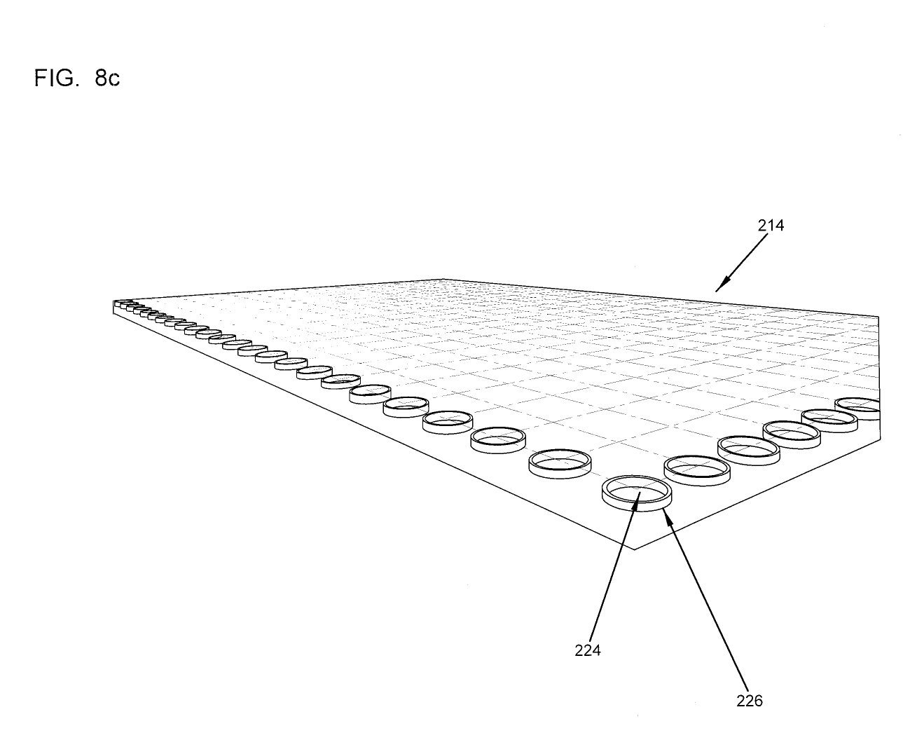

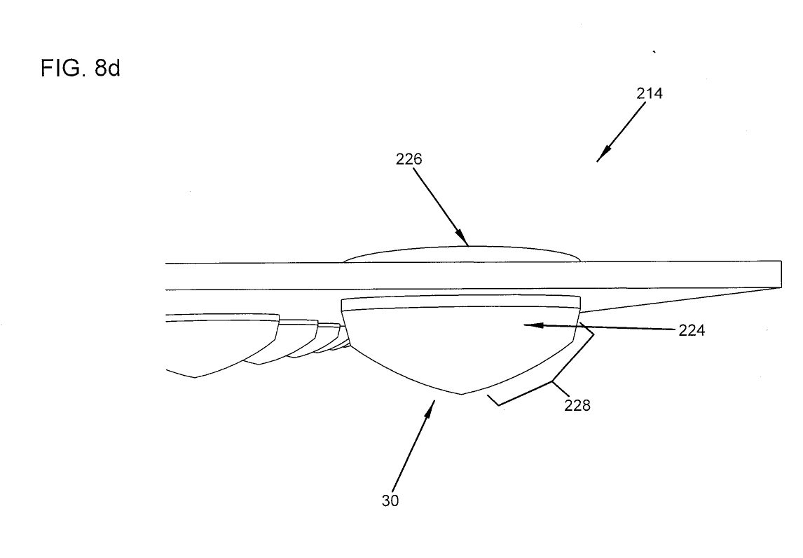

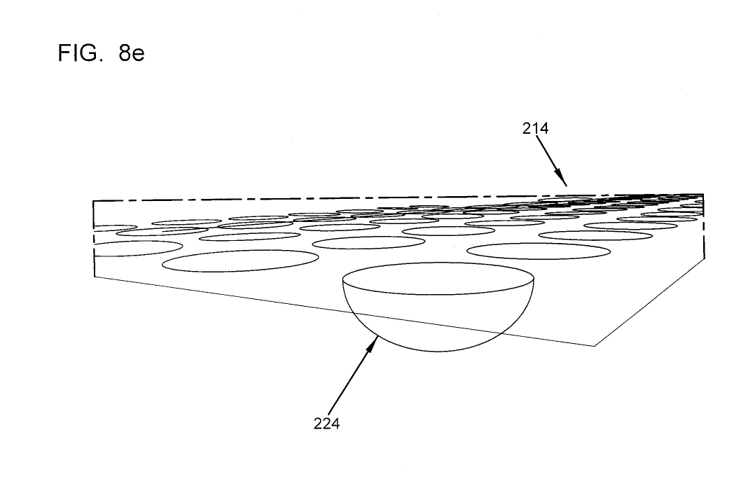

FIG. 8a illustrates a side perspective view of an interlocking fit between a first portion and a second portion in accordance with one embodiment.

FIG. 8b illustrates a side perspective view of an interlocking fit between a first portion and a second portion in accordance with another embodiment.

FIG. 8c illustrates a top perspective view of a formed second portion including an array of wells in accordance with one embodiment.

FIG. 8d illustrates a side perspective view of a well of a formed second portion in accordance with one embodiment.

FIG. 8e illustrates a side perspective view of a well of a formed second portion in accordance with another embodiment.

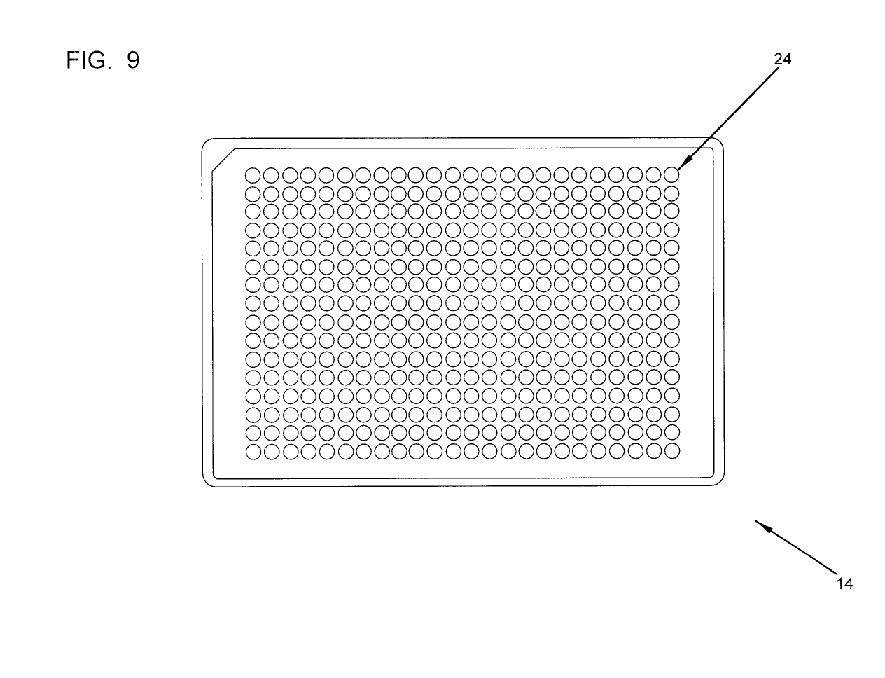

FIG. 9 illustrates a manufacturing diagram of a formed second portion in accordance with one embodiment of an industry standard compatible format.

FIG. 10 illustrates a top perspective view of a first portion in accordance with one embodiment.

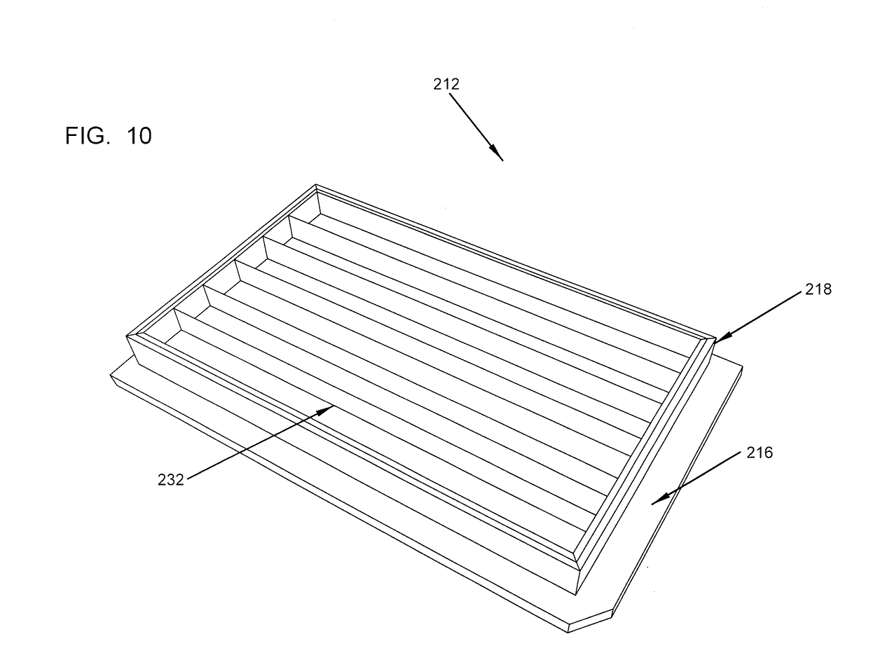

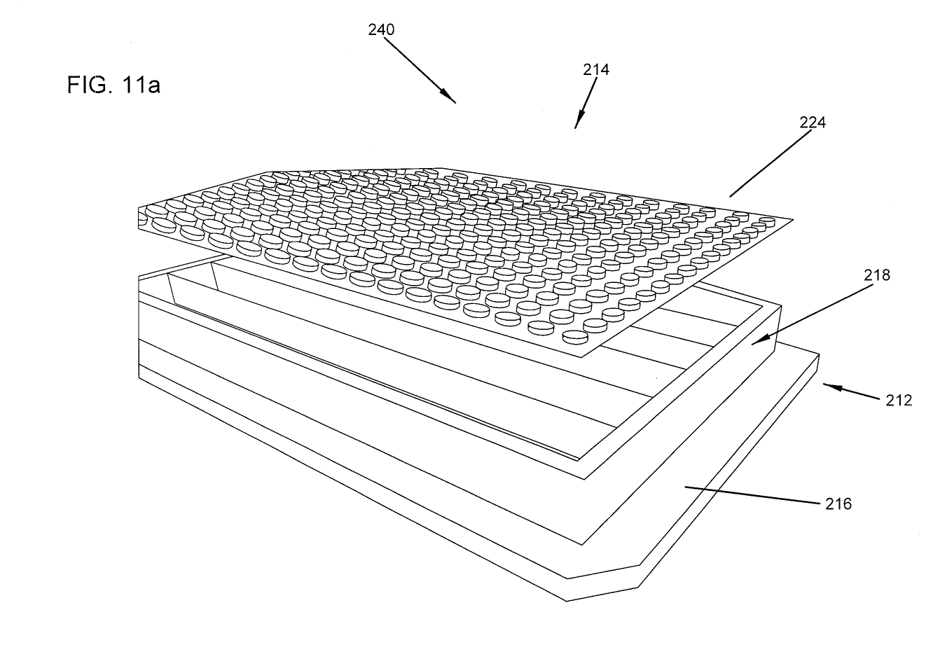

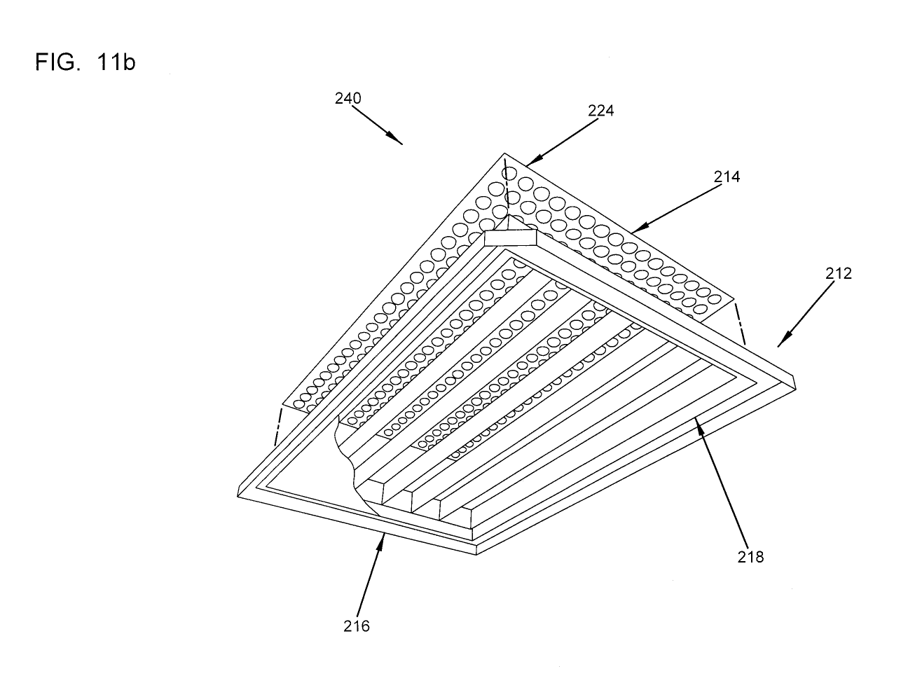

FIG. 11a illustrates a top perspective exploded view of an assembly comprising a first portion and a second portion in accordance with one embodiment.

FIG. 11b illustrates a bottom perspective exploded view of an assembly comprising a first portion and a second portion in accordance with one embodiment.

FIG. 11c illustrates a top perspective view of a microplate comprising a first portion and a second portion sliding cartridge in accordance with one embodiment.

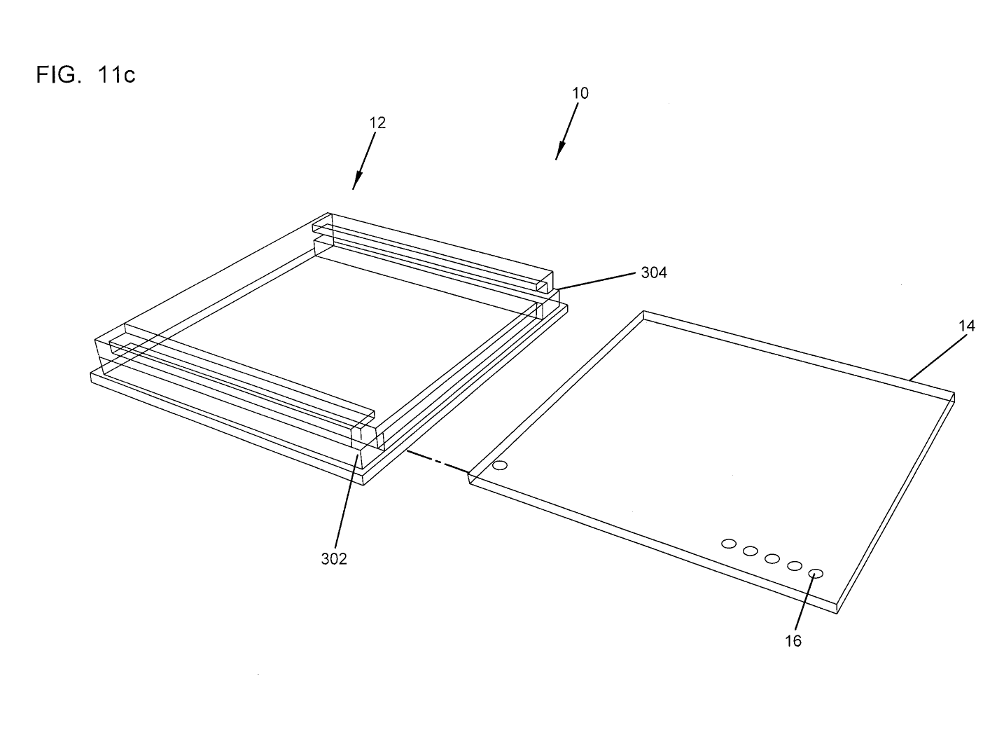

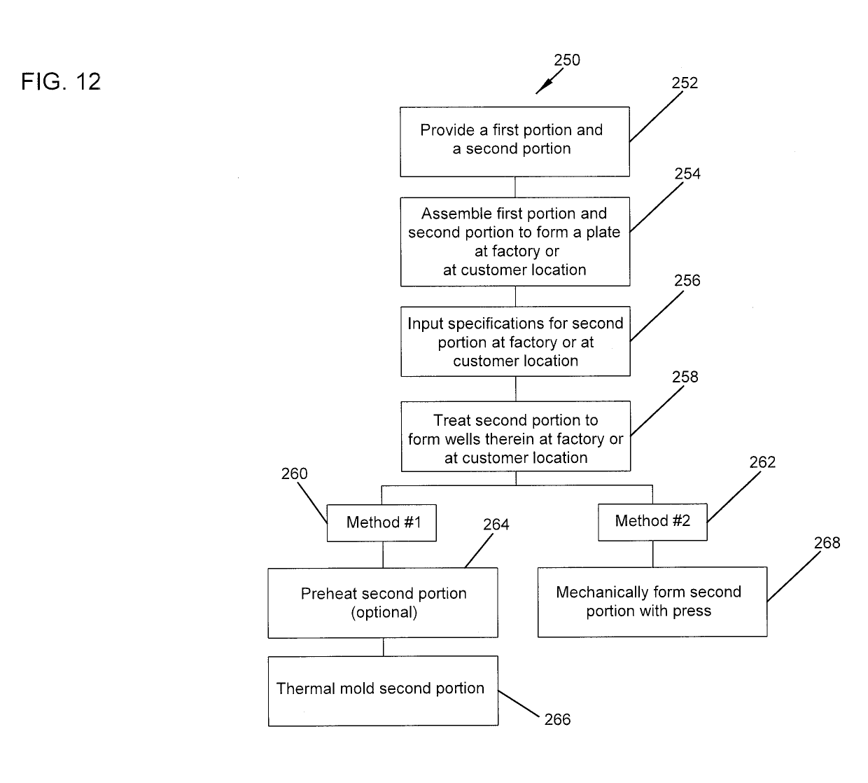

FIG. 12 illustrates a block diagram of a method for forming a microplate in accordance with yet another embodiment.

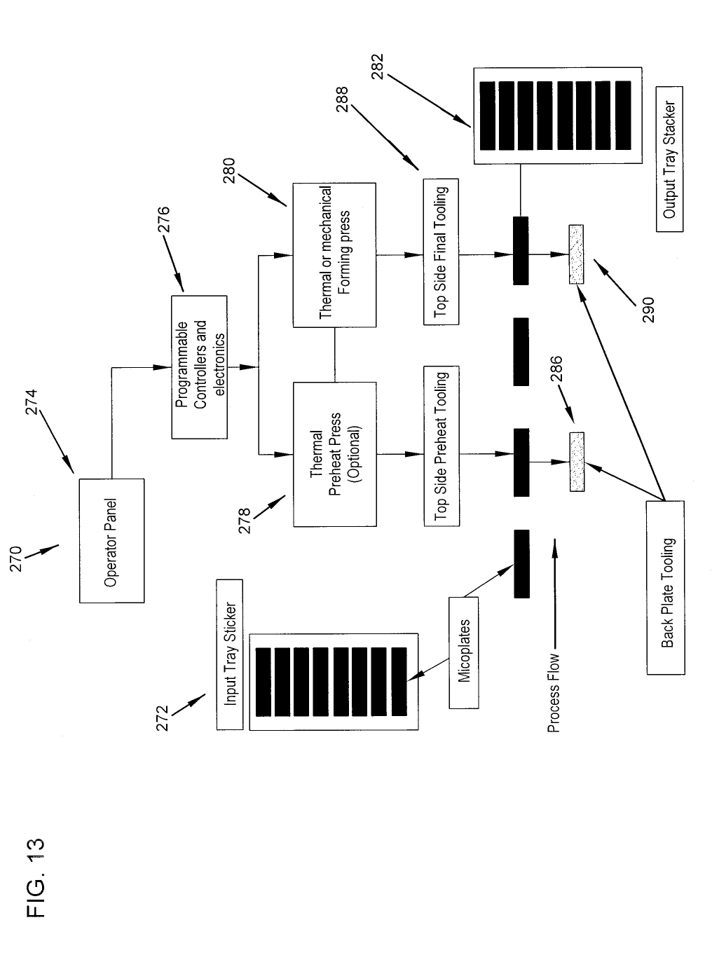

FIG. 13 illustrates a diagrammatic view of a machine and process for forming an assembly in accordance with one embodiment.

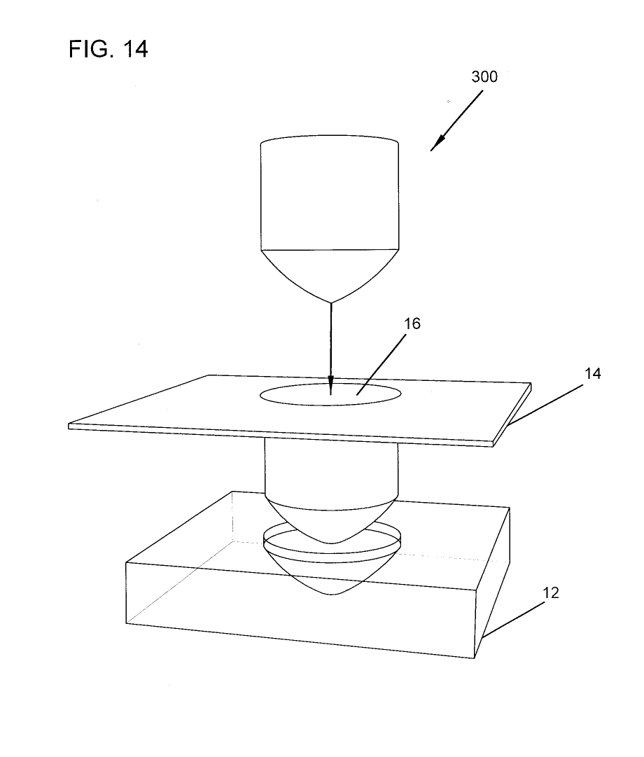

FIG. 14 illustrates an exploded perspective view of a thermal forming pin, a first portion, and a second portion in accordance with one embodiment.

### DETAILED DESCRIPTION

Methods and devices for producing an assembly, as well as the thus produced assembly, are provided. The assembly may be used in screening applications. Generally, the assembly may comprise a consumable product such as a microplate. The assembly may have custom well volumes, shapes, and dimension. For example, the wells may have volumes ranging from approximately 0.1 nanoliters to approximately 100 microliters. In some embodiments, the wells may have volumes ranging from approximately 2 microliters to approximately 10 microliters. The assembly may be a standard size, such as 96 well, 384 well, or 1536 well, or may be a custom size.

Generally, a microplate is provided. In certain embodiments, the wells may be customizable in volume and/or shape. In various embodiments, the shapes of the wells can be thermally formed with specific shape or size or with specific optical characteristics to facilitate scanning of the sample within the well with light or to effect the sample within the well or well material itself. The microplate may be formed via an over-molding process, thermally formed, or otherwise formed, as described below.

Microplate Having Co-Formed First Portion and Second Portion

A microplate having co-formed first and second portions, the first and second portions being molded in one-shot or two-shot molding, is provided. In various embodiments, the microplate may be molded with wells. By over-molding the second portion through the first portion, an increased well density and wells having a small volume may be provided. In other embodiments, the microplate may be molded as a blank. The molded microplate, having wells or being formed as a blank, may be thermally processed to modify the wells therein (where wells were formed during molding) or to form wells therein (where the microplate was formed as a blank), are described more fully with respect to the embodiment of providing separate first and second portions.

FIGS. 1a-1c illustrate a first embodiment of a microplate 10. FIG. 1a illustrates a top view, FIG. 1b illustrates a perspective bottom view, and FIG. 1c illustrates a perspective top view. FIG. 1d illustrates a detailed view of a portion of FIG. 1b. As shown, the microplate includes a first portion 12 comprising a first material and a second portion 14 comprising a second material. In the embodiment shown, the first portion 12 and the second portion 14 are co-formed—for example via one-shot or two-shot molding. The second portion 14 includes wells formed therein. A protective covering 5 may be provided over at least some part of the second portion 14. The first portion 12 includes end walls and sidewalls 12a. Notches 30, 32 (also referred to as slot openings) may be formed in the end walls and sidewalls 12a of the first portion 12. Such notches may facilitate placement and movement by lab automation equipment and aid to increase water flow and thermal transfer around the wells during thermal cycling via hot water bath.

In some embodiments, the first portion 12 may comprise a polycarbonate material and the second portion 14 may comprise a polypropylene material. While first and second materials are referenced, it is to be appreciated that the first and second materials may be different, may be the same, may be substantially the same, or may be the same material but configured with different characteristics. The protective covering 5 may comprise, for example, a polypropylene material. The protective covering 5 may be configured as a temporary covering that is thermally placed over the second portion 14 and removed when the microplate 10 is to be used. In alternative embodiments, the protective covering 5 may be placed over the second portion 14 under pressure using a pressure sensitive adhesive sealing film or otherwise applied. Further, access to the wells may be provided by removing the protective covering 5, by piercing the covering 5 over each well to access the contents, or by otherwise compromising the protective covering.

In a specific embodiment, the microplate is formed with a second portion 14 having 1536 wells, each of approximately 2 microliters.

As is described more fully below, in some embodiments, the microplate 10 may be formed by one-shot molding with the first material and the second material being the same material, for example. In other embodiments, the microplate 10 may be formed by two-shot molding (also referred to as overmolding) with the first material and the second material being different materials, for example. In yet other embodiments, the first portion and the second portion may be separately provided and assembled.

FIGS. 2a-2d illustrate side views of the microplate 10 of FIGS. 1a-1c. FIG. 2a illustrates a detailed side view of a corner of the microplate 10. FIG. 2b illustrates a side view of the microplate. FIG. 2c illustrates an end view of the microplate. FIG. 2d illustrates a chamfer of the microplate. The first portion 12 is shown in various segments as white or with a first cross-hatching and the second portion 14 is shown with a second cross-hatching. As shown, the microplate first portion 12 includes side walls and end walls 12a, a bottom surface 12b, and a top surface 12c. Notches 32 (also referred to as slot openings) are provided along the side walls 12a and notches 30 are provided along the end walls 12a. Any suitable number of notches may be provided. For example, in FIG. 2b, four notches are provided along each side wall and, in FIG. 2c, two notches are provided along each end wall. In these embodiments, the second portion 14 is integrally formed, for example via one-shot or two-shot molding, with the first portion and comprises the wells 16. In some embodiments, the wells 16 have substantially flat bottom surfaces 18. Similarly, the first portion 12, at the top portion of the microplate 10, may be provided with a flat bottom surface 20. In some embodiments, the bottom surfaces 18 of the wells and the bottom surface 20 of the first portion 12 of the top portion of the microplate may be substantially in line. In other embodiments, as shown, a spacing 13 may be provided between the bottom surfaces 18 of the wells and bottom surface 20 of the first portion 12 top portion of the microplate. In some embodiments, this spacing 13 may be used for changing the depth of the wells during subsequent thermal treatment.

As shown, a chamfer 15, may be provided, shown in FIG. 2d, and described more fully with respect to FIG. 6c. Generally, the chamfer 15 facilitates overmolding of the material of the second portion 14 through the material of the first portion 12. As may be appreciated, the chamfer 15 may be filled with secondary material after overmolding of the secondary material through the primary material.

FIG. 2e illustrates one embodiment of a bottom surface of a microplate 10. In the embodiment shown, the bottom surface 20 is substantially flat. The bottom surface 20 comprises a matrix of secondary material 7 (the material of the second portion 16) and primary material 9 (the material of the first portion 12). The matrix of secondary material 7 reduces warpage of the microplate after molding and/or during use. As may be appreciated, using different materials for the first and second portion may lead to different shrinkages after the molding process and additional thermal cycling of the microplate. For example, under like conditions, polypropylene generally shrinks 0.030 per square inch and polycarbonate generally shrinks approximately 0.006 per square inch. Thus, when the microplate first portion comprises polycarbonate and the microplate second portion comprises polypropylene, the polypropylene shrinks more than the polycarbonate and this causes the microplate to warp around the polypropylene shrinkage. Thus, if the second portion polypropylene is provided only along a top of the microplate, the microplate will tend to warp upwardly.

Accordingly, additional secondary material 7 may be provided to equalize the secondary material 7 of the second portion. The additional secondary material may be provided underlying the first portion supporting the second portion. The additional secondary material may be provided as a generally solid surface, as a matrix, as overflow of the well material through openings in the first portion, or in any other suitable configuration. The additional secondary material may be referred to as a sub-portion of secondary material and may be provided below at least a portion of the first portion. Generally, the additional secondary material 7 shrinks equally to the secondary material of the second portion. Thus, when secondary material is provided along the second portion, over the first portion, and along a bottom surface of the first portion, the first portion is pulled equally upwardly by shrinkage of the top of the second portion (the well portion) and downwardly by shrinkage of the additional secondary material.

In the embodiment of FIG. 2e, the matrix of secondary material 7 provides a back support for the microplate 10. The matrix provides material shrinkage equalization of stresses, thereby reducing warpage. The primary material 9 and the secondary material 7 together form columns 11a and 11b in the matrix. These columns may have varied visual characteristics, optical characteristics, or other characteristics. In some embodiments, the columns may create a stripe effect is created between columns 11a and 11b.

As described, the microplate 10 may be provided with custom wells. Such wells may be provided by thermally forming or pressing the second portion. Such thermal forming may be done to wells already formed in the second portion to modify the shape or size of the wells or may be done in a blank second portion to form wells in the second portion. The wells 16 may have any suitable configuration, several of which are described more fully below. It is to be appreciated that the wells 16 may have alternative sizes, shapes, and configurations and that the microplate 10 may be custom formed, shaped, or patterned.

FIG. 3 illustrates a first well embodiment. As shown, the well may have a sloped entry 17. The well 16 may have a generally square opening, as shown, or may have other configurations. In the embodiment of FIG. 3, the well walls 19 taper towards the bottom of the microplate. The well wall may have any suitable taper or may be substantially perpendicular to a top surface of the microplate. In some embodiments, the taper of the well wall may vary over the depth of the well. A raised rim 21 (also referred to as a chimney) may be provided at a top portion of one or more wells to facilitate sealing of a thermal film, such as the protective polypropylene cover 5 shown in FIGS. 1a-1c. The protective cover may be coupled to the raised rim 21 through any suitable method including, for example, thermal sealing or adhesives. In alternative embodiments, the wells may have flat tops, flush with the adjoining wells.

FIG. 4a illustrates a second well embodiment. In the embodiment shown, the wells 16 are generally convex along the sides thereof. Thus, a width of the well 16 may taper from a top surface 22 to a bottom surface 20. As shown in FIG. 4a, the well 16 may comprise an upper portion 24 and a lower portion 26. The upper portion 24 has a more aggressive taper and the lower portion 26 has a less aggressive taper. In one embodiment, the upper portion 24 may have a volume of approximately 1.25 μL and the lower portion 26 may have a volume of approximately 2.00 μL (2 microliters). The width of the bottom surface 20 may vary in accordance with the desired well volume. As discussed with respect to FIG. 2d, additional secondary material may be provided at the bottom surface of the well to form a matrix with the primary material to reduce warpage. FIG. 4b illustrates a top view of a cutaway of an array of wells 16. As shown in FIG. 4b, the wells 16 may have generally rounded square openings.

In various embodiments, the wells 16 may have generally circular, oval, square, rectangular, or other openings. In some embodiments, the wells may have sloped entries. The wells 16 may be provided as uniform sizes and shapes and uniformly spaced or there may be variation between wells 16 on a single microplate. The wells may have any suitable volume, for example a volume ranging from approximately 0.1 nanoliters to approximately 100 microliters, or from approximately 1 microliter to approximately 10 microliters. The wells on a given plate may be uniform in size or may be varied. The microplate may be provided with any suitable number of wells, such as 96 wells, 384 wells, 1536 wells, or other number of wells. The wells may be provided in any variety of shape or pattern. The bottom dimension may be designed to have different opacity ratings for lighting and reading from the bottom of the well. The well bottom may also be thermally formed with optical characteristics of a lens to improve optical reading.

In various embodiments, the microplate may be suitable, for example, for thermal cycling on Peltier Block heaters or Peltier thermal cycling units.

In some embodiments, a bar code may be provided on a surface of the microplate assembly. For example, in one embodiment, a bar code is provided on a side surface of the microplate assembly.

Accordingly, in various embodiments, the microplate comprises a first portion (also referred to as a bottom portion or a frame portion) and a second portion (also referred to as a well portion). The first portion may comprise a substantially rigid material and provides stability to the microplate while the second portion comprises a material that may be thermally shaped. For example, the first portion may comprise polycarbonate and the second portion may comprise polypropylene. In alternative embodiments, the microplate may comprise a substantially unitary construct of a single material such as polypropylene. In yet other embodiments, more than two materials may be used.

The first portion may function as a frame for the microplate. The first portion may be manufactured of a material having rigid thermal properties. For example, the first portion may be manufactured of material that remains rigid during and after thermal cycling of the assembly, such as PCR and incubation processes. Suitable materials for the first portion thus comprise, for example, polymers such as polycarbonate, resins, ABS, metal foils, metals, fiberglasses, composites, or mixtures of these and other materials.

The second portion may be manufactured of a material suitable for thermal or mechanical forming. For example, the second portion may be manufactured of a thermal-forming polymer such as polypropylene, metal foils, metals, fiberglass, composites, or mixtures of these and other materials. Differing colored materials can be used in the well material for improvement of light band-pass or band-blocked wave length filtering for improved scanner or reader performance or protection of the material or compound being stored should it degraded by external light sources. In embodiments where material between the wells is substantially opaque, light contamination can be limited.

As discussed, in some embodiments the first portion and the second portion may be the same material. Generally, when two materials are used, the second portion is manufactured of a material for thermal or mechanical forming while the first portion is manufactured of a material having rigid thermal properties. In embodiments having a single material, the single material may be, for example, the material of the second portion. Such embodiments may be useful in applications where the microplate does not undergo thermal cycling or may not benefit from rigid thermal properties. Thus, for example, the microplate may be formed entirely of a polypropylene or other material.

The first portion and the second portion may each be generally planar. Dimensions of the first portion and the second portion may be varied according to specific applications. The first portion and the second portion may have corollary lengths and widths such that juxtaposition, whether via coupling or co-forming, of the first portion and the second portion provide a substantially in-line plate. The Society for Biomolecular Screening (SBS) has promulgated standards for well positions in microplates. As may be appreciated by one skilled in the art, the first portion and the second portion may be sized to conform with specifications as set forth in SBS standards.

In some embodiments, the second portion may be coated on an upper surface thereof. For example, the second portion may be coated to form a hydrophilic surface, a hydrophobic surface, a non-binding surface, a medium binding surface, a high binding surface, a tissue culture treated (TC) surface, an ultra low attachment surface, a poly-d-lysine coated surface, a carbohydrate binding surface, a photo-reactive surface, an amine surface, a carboxy surface, an epoxy surface, or a custom coated surface. These surfaces is described more fully below.

A non-binding surface may be a nonionic hydrophilic (polyethylene oxide-like) surface that minimizes molecular interactions. It may be used for reducing non-specific protein and nucleic acid adsorption at low concentrations and may help in increasing assay signal-to-noise ratios. A medium binding surface may be a hydrophobic surface that assists in binding biomolecules through passive interactions. It may be used for immobilizing large molecules that have hydrophobic regions that interact with the surface (e.g., antibodies). A high binding surface may be provided through a surface treatment that assists in binding medium and large biomolecules that have ionic groups and/or hydrophobic regions. A tissue culture treated surface may be used for attachment and growth of anchorage-dependent cells. An ultra low attachment surface may be a covalently bonded hydrogel designed to minimize cell attachment, protein absorption, enzyme activation and cellular activation. Such surface is noncytotoxic, biologically inert and nondegradable. A poly-d-lysine coated surface helps improve attachment of difficult to attach cells. A carbohydrate binding surface may have hydrazide groups that covalently couple to carbohydrate groups. This may be useful for assays that require site-directed orientation of biomolecules like oxidized antibodies, carbohydrates, and glycosylated proteins while still maintaining enzymatic or immunological activity. A photo-reactive surface covalently may immobilize biomolecules via abstractable hydrogens using UV illumination which results in a carbon-carbon bond. Although this linkage is non-specific, it is helpful for immobilization of double stranded DNA, antigens and mixtures of biomolecules like cell lysates. An amine surface has positive charged amine groups that can be used for covalent immobilization via bifunctional crosslinkers. A carboxy surface has negatively charged carboxy groups that can be used to covalently immobilize proteins and synthetic oligonucleotide derivatives. An epoxy surface has uncharged (non-ionic) epoxy groups which can be used to covalently immobilize nucleic acids, synthetic oligonucleotides and proteins. A custom coated surface may be provided including: Streptavidin, Phospholipid, Protein A, WGA, Collagen, etc.

Co-Forming of the First Portion and Second Portion the Microplate

In various embodiments, a method for forming the microplate assembly comprises molding of the microplate to co-form the first portion and the second portion of the microplate is provided. Wells may be provided in the microplate in custom shapes, sizes, and patterns, either during the molding process or later via thermal treatment. For example, the wells may be formed with one shape or size during molding and later thermally treated to change the shape, depth, or other characteristic of the wells.

In some embodiments, the microplate may be formed using a two-shot molding or over-molding process wherein a first portion and a second portion are thereby integrally formed. Suitable methods of two-shot molding are discussed below. In alternative embodiments, the microplate may comprise unitary first and second portions, formed, for example, by one-shot molding.

In accordance with some embodiments, the microplate assembly may be formed using multi-component molding or over-molding. Two-shot molding is described herein but it is to be appreciated that other forms of multi-component molding, such as co-injection or hard-soft combinations, may alternatively be used. Two-shot molding is a multi-step molding process that produces an assembly comprised of two or more integrated components. Two-shot injection molding allows the first material to cool before the second one is injected. In some embodiments, injection of the material for molding is done from the bottom. As the molded parts are created, the flow path for filling of the mold inherently forms interlock between the two components. Variables for consideration when using two-shot molding to form the microplate assembly include draft, injection pressure, and mold temperature. During two-shot molding, the first shot structure is fully supported by the mold as the second-shot is injected. In accordance with various embodiments of two-shot molding, the first portion is formed during the first shot and the second portion is formed through the first portion during the second shot.

The molds for the first portion and for the second portion may be designed for specific applications. In some embodiments, the mold for the first portion may be configured to form a chamfer in the first portion to facilitate flow through of the second material through the first portion during over-molding of the second portion. In some embodiments, the mold for the first portion and/or the second portion may be configured to provide a sub-layer of secondary material along a bottom surface of the first portion supporting the second portion to reduce warpage. Thus, for example, the second portion mold may be provided with sufficient volume to provide secondary material over the first portion, for over-molding, but also to provide secondary material under at least a portion of the first portion.

In accordance with other embodiments, the microplate assembly may be formed of a single material using a one-shot molding process. This single material can be molded with wells and/or may be thermally treated to have desired well volumes, shapes, or patterns, in the molding factory. In some embodiments, the microplate assembly, formed via one-shot or two-shot molding, may be molded with a design enabling it to be thermally formed later within the distribution or at the customer location with thermal forming machines.

FIG. 5a illustrates a first embodiment of two-shot molding comprising two-shot rotary molding of the microplate assembly. The method may be used to produce a microplate assembly such as discussed herein. As shown, the method 100 comprises providing a mold and closing the mold (block 102). A first material, for the first portion or frame, is injected at position one in the mold (block 104). This may be referred to as the first shot. The first material may comprise, for example, polycarbonate. A second material, for the second portion, is injected at position two in the mold (block 106). This may be referred to as the second shot. The second material may comprise, for example, polypropylene. Accordingly, the second material is injected through the first material. The mold is cooled (block 108) and opened (block 110). The finished part, a combination of the first portion (frame) and second portion (wells), is ejected from position two (block 112). The material in position one, the frame, is rotated to position two, for example by rotating the core side of the mold approximately 180 degrees (block 114). Thus, for example, the polycarbonate frame is moved to the polypropylene molding position. The mold is cooled (block 116) and opened (block 118). The finished part, the frame, is ejected from position two (block 120).

FIG. 5b illustrates a second embodiment of two-shot molding comprising a two-material over-mold of the microplate assembly. As shown, the method 130 comprises providing a first mold and a second mold (block 132). The second mold may be a well mold. The first mold is closed (block 134). A first material, for the first portion or frame, is injected into the first mold (block 136). This may be referred to as the first shot. The first mold is cooled (block 138) and opened (block 140). The molded material from the first mold is ejected (block 142). The molded material is transferred to the second mold (block 144). Such transfer may be automated or manual. The second mold is closed (block 146). A second material, for the second portion is injected into the second mold (block 148). This may be referred to as the second shot. The second material may be, for example, polypropylene. The mold is cooled (block 150) and opened (block 152). The finished part is ejected (block 154). This process is then repeated for each additional part.

In some embodiments, the first shot mold may be formed to provide access to components of the two-shot machine for executing the second shot. FIG. 6a illustrates a molded first portion 12 subdivided into portions 160, each portion 160 having a port 162 for receiving an injection apparatus. In the embodiment shown, the first portion 12 is subdivided into eight portions. In alternative embodiments, the first portion 12 may be subdivided into more or fewer portions or may not be subdivided. Generally, the ports 162 facilitate injection the second material through the first portion to over-mold the second portion over the first portion.

FIG. 6b illustrates the molding of the first portion 12 and the second portion 14. As described with respect to FIGS. 5a and 5b, the first shot 164 is injected to form the first portion 12. A port 162 is provided in the first portion 12. In some embodiments, the port 162 may be part of a chamfer 15, shown in FIG. 6c. An injection tool 170 engages the port 162 and injects the second shot 166, through the first portion 12. The second shot forms the second portion 14. With the second shot being injected through the first portion 12 and the second portion 14 thus being coformed with the first portion 12, no further coupling need be done between the first portion 12 and the second portion 14. The mold for the second portion 14 may have wells for forming a molded second portion with wells. Alternatively, the mold for the second portion 14 may be configured for forming a blank second portion. Either of a second portion having wells or a blank second portion may be thermally treated to change the shape or depth of the wells or to form the wells

FIG. 6c illustrates a chamfer 15 to facilitate directing of a second portion (or secondary) material to the wells 16 formed in the first portion. In the embodiment shown, the chamfer 15 is sloped. In various embodiments, chamfers 15 may be provided at one or more locations on the first portion 12. The chamfers 15 may provide the ports 162 for receiving the second portion material and facilitate over molding second portion material into the first portion frame 12. Generally, the chamfer forces second portion material to flow into the top section of the assembly first, thus filling from top to bottom. This facilitates control of flow direction of the second material, for example, of polypropylene. By urging the material to flow from top to bottom, the likelihood of the polypropylene pushing the polycarbonate frame material to the top of the mold and cutting off the polypropylene from filling over the top of the plate is reduced. The chamfers provide a path for the second material to flow around to the top first, thus pushing the first portion away from the top of the mold and allowing the top to fill in first.

Accordingly, in some embodiments, a microplate assembly may be formed via two-shot molding (or over-molding) and in other embodiments a microplate assembly may be formed via one-shot molding. The formed microplate assembly may be thermally treated to modify wells formed therein or to provide wells therein. To form a microplate in accordance with one embodiment, an operator may input specifications regarding the desired output. The operator may input number of wells, well volume, well dimension, well shape, etc. Optionally, the operator may input varied well volumes and specifications for a single microplate such that the size and shape of well varies on the microplate.

Microplate Having Separately Formed First and Second Portions

In alternative embodiments, a blank for the microplate is created by separately providing, and coupling, a first and second portion. It is to be appreciated that the molding process described above may be used to form a blank. Alternatively, the molding process may be used to form a microplate having wells that are subsequently thermally formed as a blank would be thermally formed. FIG. 7 illustrates a formed blank, FIG. 8a illustrates uncoupled first and second portions as thermally formed, and FIG. 5c illustrates a microplate formed by coupling separately provided first and second portions.

FIG. 7 illustrates a blank 210 that may be used in such a method. As shown, the blank 210 comprises a first portion 212 and second portion 214. Each of the first portion 212 and the second portion 214 may be comprised of a polymeric material, or other suitable material. The first portion 212, or bottom portion, may be comprised of a material that will remain substantially rigid after thermally cycling, such as PCR and incubation processes. The second portion 214, or well portion, may be comprised of a material that can be shaped and/or formed by stamping with a thermal or mechanical tool. Generally, the first portion 212 and the second portion 214 may be molded, for example by injection molding. Alternatively, as described, the first portion and the second portion may be coformed via, for example, two-shot molding.

As assembled into a blank 210, the first portion 212 may comprise a bottom portion of the assembly, also referred to as a base frame, and the second portion 214 may comprise a top portion of the assembly, also referred to as a well portion. Accordingly, the blank, as assembled, may comprise a second portion 214 overlaying a first portion 212.

In embodiments wherein the first portion and the second portion are provided as blanks or otherwise separately formed, the first portion and the second portion may be coupled to form the microplate. FIGS. 8a and 8b illustrate coupling of the second portion 214, as treated or thermally formed, to the first portion 212. As shown, one method of coupling may be a press fit or friction fit. In the embodiment shown, the periphery of the second portion 214 may be formed with a male fitting 222 while the periphery of the first portion 214 may be formed with a corollary female fitting 224. The male fitting 222 may be press or friction fit into the female fitting 224 to couple the second portion 214 in position on the first portion 212. The male fitting in the second portion and/or the female fitting in the first portion may be provided in any suitable manner. In one embodiment, the second portion 214 is molded with a generic male fitting such as a rectangular tab. Plastic or other material may then be poured around the tab to form the specific male fitting.

Other manners of coupling the second portion 214 to the first portion 212 may alternatively be used. For example, an adhesive may be placed along the second portion 214 and/or along the first portion 212 at the intersection of the second portion 214 with the first portion 212. In some embodiments, an adhesive may be used in addition to the press fitting of the male fitting 222 of the second portion 214 into the female fitting 224 of the first portion 212. Generally, mechanical, adhesive, thermal, sonic, laser, or other coupling mechanisms may be used.

It is to be appreciated that in embodiments wherein the first portion and the second portion are integrally formed, such as by two-shot molding, it is not necessary to couple the first portion and the second portion.

FIGS. 8c-8e illustrate various views of second portions 214 of a microplate. It is to be appreciated that the second portions may be formed integrally with a first portion, as described with respect to the molded microplate assembly embodiments, or may be formed separately. Thus, description of various characteristics of the second portions and wells may be applied to any of the microplate embodiments described herein.

FIG. 8c illustrates a top perspective view of a second portion 214 as formed for a microplate. As shown, the second portion 214 comprises an array of wells 224. As will be described, the wells may have custom shapes, sizes, volumes, or other specifications.

FIGS. 8d and 8e illustrate side perspective views of a second portion 214. As shown, the well 224 includes a diameter at the top. The diameter size may be chosen for specific dispensing equipment. The top portion of the well may include a circular ridge 226 (also referred to as sealing rim or chimney). The circular ridge 226 may aid in sealing of the wells by cover tapes such as a protective polypropylene covering. The well 224 further has a sidewall 228. The sidewall may have a specific angle chosen for sample retention. The shape of the well 224 may be designed for specific fluid retention characteristics. For example, when the well 224 is shaped as a cone, a cone angle is provided for specific fluid retention characteristics. The well 224 further has a bottom 230. The bottom dimension may be designed to have different opacity ratings for lighting and reading from the bottom of the well. The well bottom may also be thermally formed with optical characteristics of a lens to improve optical reading. Generally, each well 224 may be formed to have a volume ranging from approximately 0.1 nanoliters to approximately 100 microliters. In some embodiments, each well 224 may have a volume of approximately 2 microliters. With the lower volume range, a consumer may minimize use of expensive chemicals and reagents.

FIG. 9 illustrate a manufacturing diagram for a second portion 214 having sample specifications. These specifications are intended for illustrative purposes only and are not limiting.

FIG. 10 illustrates a top perspective view of a first portion 212. The first portion 212 may have a substrate 216 and sidewalls 218. The substrate 216 and sidewalls 218 may formed separately or as a unitary construct. In some embodiments, the first portion 212 may comprise a separate substrate 216 and sidewalls 218 coupled to the substrate 216. Coupling may be done in any suitable manner. In one embodiment, the substrate and sidewalls are injection molded as a unitary first portion 212. The substrate 216 and sidewalls 218 may be formed of the same or different materials. At least the substrate 216 may be formed of a rigid material designed for high temperature and non warpage. A reinforcing structure, such as reinforcing ribs 232 or structural lattice with individual well openings, such as shown and described with respect to the matrix of FIG. 2e, may be provided within sidewalls 218. The reinforcing structure may add support for the second portion 214 as well as provide optical isolation between wells and emission equipment. In embodiments where material between the wells is substantially opaque, light contamination can be limited.

FIGS. 11a and 11b illustrate various exploded views of a microplate assembly 240. As shown, the microplate assembly 240 comprises a rigid first portion 212 and a formable second portion 214. The formable second portion 214 is treated to form wells 224. The first portion may include a substrate 216 and sidewalls 218. FIG. 11a generally illustrates a top view of the microplate assembly 240 while FIG. 11b generally illustrates a bottom view of the microplate assembly 240. While FIG. 11a is shown with reference to assembling and thermal forming a blank, it is to be appreciated that the portions 212 and 214 may alternatively be formed and bonded through an over-molding process in which portion 214 is formed around 212 through an injection molding process, such as described above.

FIG. 11c illustrates an alternative microplate embodiment. The microplate 10 includes a standard first portion 12 and a customizable second portion 14. The first portion 12 acts as a frame and the second portion 14 acts as an interchangeable cartridge. Accordingly, wells 16 may be formed in the second portion 14 in any suitable configuration, shape, or size and the second portion 14 may be inserted into receiving channels 304 of the first portion 12. Locking mechanisms 302 may be provided on the first portion 12 for locking the second portion 14 in place in the first portion 12. In alternative embodiment, locking mechanisms may be provided on the second portion or may be provided on both the first portion and the second portion. Using the embodiment of FIG. 11c, a facility may stock standard first portions 12 and customize second portions 14 as desired for certain applications. Such customization may be, for example, via thermally treating the second portion 14. Alternatively, custom second portions 14 may be molded.

Thermally Treating the Second Portion of the Microplate

FIG. 12 illustrates a method 250 of producing an assembly such as a microplate. As shown, the method 250 comprises providing a first portion and a second portion (block 252). As described with respect to FIG. 7, the first portion and the second portion may be provided as a blank. In the embodiment shown, the first portion and second portion are assembled to form a blank (block 254). Thus, the first portion may be coupled to the second portion. As described herein, the second portion is coupled to the first portion to provide a blank prior to treatment of the second portion to provide or modify wells therein. In alternative embodiments, the second portion may first be treated to provide or modify wells therein and then coupled to the first portion. Further, in some embodiments, a microplate assembly may be provided substantially formed, such as by the molding technique previously described, and a thermal forming technique may be used to modify the wells formed therein. Provision and assembly of the blank (blocks 252 and 254) may be done at a supplier location.

As will be described, the blank may be treated to form a microplate. Specifically, the second portion may be treated to form or modify wells therein. Prior to treating the second portion, an operator may input specifications of the desired output including specific size, shapes, and dimensions of wells (block 256). Additionally, the operator may input the spacing of the wells and the number of wells to be formed on the second portion. In some embodiments, the operator may not input new specifications and previously entered specifications may be used for treating the second portion.

The second portion is treated to form wells according to the specifications entered at block 256 (block 258). The size, shape, and dimensions of the wells of the microplate may be customized for any application. Forming of the wells may be done at the producer facility or at the consumer facility. Thus, advantageously, a consumer may input desired specifications at their facility and output a customized microplate nearly immediately. Further, forming of the microplate from a blank, as provided herein, is rapid and cost effective. Treating the blank to form wells therein may be done by stamping with thermal, mechanical, or other processes. Two possible processes for treatment (block 258) are shown at blocks 260 and 262.

Block 260 illustrates a method of treatment involving heat treatment of the second portion. Again, it is to be appreciated that heat treatment may be done to a microplate or blank formed via a molding process as previously described. Thus, for example, a microplate having wells of 2 microliters may be heat treated to increase the size, for example by increasing the depth, of the wells. This embodiment may comprise first and second stages (blocks 264 and 266 respectively). The first stage may comprise preheating the second portion (block 264). Such preheating brings the second portion to a temperature suitable for final forming. As may be appreciated by one skilled in the art, preheating is optional. The second stage of treating the second portion may comprise forming the second portion to have wells of a size, shape, and dimension as set by an operator (block 266). Treatment of the second portion (blocks 260, 264, and 266), and machining used to treat the second portion, are described more fully below with reference to FIG. 13.

Block 262 illustrates a method of treatment involving mechanical formation of wells in the second portion. This embodiment may comprise mechanically forming wells using a press (block 268).

FIG. 13 illustrates a device and process for forming an assembly in accordance with one embodiment. The device is referred to herein as a “microplate forming machine”. Such reference is intended to be illustrative only and is not intended to limit the described device in any way.

As shown, the microplate forming machine 270 comprises an input tray stacker 272, an operator panel 274, programmable controllers and electronics 276, an optional thermal preheat press 278, a thermal forming or mechanical press 280, and an output tray stacker 282.

To form a microplate in accordance with one embodiment, an operator at the operator panel 274 uses the programmable controllers and electronics 276 to input specifications regarding the desired output. The operator may input number of wells, well volume, well dimension, well shape, etc. Optionally, the operator may input varied well volumes and specifications for a single microplate such that the size and shape of well varies on the microplate.

The operator loads a blank, comprising a second portion and a first portion, into the input tray stacker 272. The blanks are moved from the input tray stacker 272 into an inline tray handling device for forming. The inline tray handling device comprises one or more of the optional thermal preheat press 278 including a top side preheat tooling 284 and a first back plate tooling 286, and the thermal forming press 280, including a top side final tooling 288 and a second back plate tooling 290. In the embodiment shown, each blank thus processes from the input tray stacker 272 to the thermal preheat press 278, comprising a top side preheat tooling 284 and a first back plate tooling 286. Top side preheat tooling and back plate tooling is done concurrently. The top side preheat tooling 284 heats the second portion to a temperature suitable for treatment of the second portion to form wells therein. The back plate tooling 286 supplies support as a mating side of the blank during the forming process. In some embodiments, top side preheat tooling may not be performed and the thermal preheat press 278 may be omitted. As shown, the preheated blank processes to the thermal forming press 280, comprising a top side final tooling 288 and a second back plate tooling 290. The top side final tooling 288 treats the second portion to forms wells in the second portion in accordance with specifications input by the operator into the programmable controllers and electronics 276. The back plate tooling 290 supplies support as a mating side of the plate during the forming process. After thermal forming, the microplate is substantially formed and is loaded into the output tray stacker 282. Movement of the plate from input tray stacker 272, to the thermal preheat press 278, to the thermal forming press 280, and to the output tray stacker 282 may be automated.

FIG. 14 illustrates a molding pin 300 that may be used to shape a second portion 14. The molding pin 300 may be, for example, part of top side final tooling 288 of FIG. 13. As shown, the second portion 14 is exploded from the first portion 12. In use, the second portion 14 may be provided on the first portion 12 for thermal treatment. The second portion 14 may be preformed with wells that are to be thermally treated to change the size of the wells or may be formed as a blank. In the embodiment of FIG. 14, the second portion 14 includes a well 16. The first portion 14 acts as a negative shape molding backer. The molding pin 300 has a positive and customizable shape insofar as different molding pins 300 may be provided for different shapes and sizes of wells. The molding pin is pressed into the second portion 14 to change the shape or size of the well 16. Such pressing may be done with thermal treatment.

In various embodiments, the microplate forming machine may be modified to produce microplates using mechanical means, may be modified to omit preheating, or may be otherwise modified as would be obvious to one skilled in the art. Specifically, in an alternative embodiment, the wells may be formed using mechanical pressure. Mechanical pressure may be used to form wells in the second portion, for example, a polypropylene layer. This method may be particularly useful for forming wells around 0.1 nanoliters (although wells of other volumes may also be formed using this method).

The microplate forming machine may be used at a factory or on location, greatly facilitating customization by the user of the microplate. Thus, a laboratory may use the microplate forming machine and method of producing microplates having special well volume on demand as they need the microplates for daily testing. Using the described method and apparatus, it is possible to form microplates having a combination of volumes, shapes and sizes for specialized applications requiring varying volumes of compounds.

A microplate assembly comprising a first portion and a second portion is thus provided herein. The second portion substantially overlays the first portion. The second portion comprises a forming material, for example polypropylene, and is treated to form or modify wells therein. The first portion comprises a material that remains rigid during processes such as thermal cycling, for example polycarbonate. The first portion and/or the second portion may be molded, such as by injection molding, to form a microplate or to form a blank. The blank may be treated, and, more specifically, the second portion of the blank may be treated, to form wells in the second portion. Alternatively, a second portion with wells formed therein may be treated to modify the shape and/or size of the wells. Wells in the second portion may have industrial standard sizes, volumes, shapes, and specifications or may have custom sizes, volumes, shapes, and specifications. For example, in some embodiments, wells in the second portion may have a volume of between approximately 0.1 nanoliters and approximately 100 microliters. In other embodiments, wells in the second portion may have a volume of between approximately 10 microliters and approximately 2 microliters. In accordance with some embodiments, an array of wells is formed in the second portion wherein well specifications vary across the array.

In various embodiments, a microplate may be manufactured, via molding or stamping as described herein, having a standard SBS format of 96, 384, 1536 and 3456. However, the described method and apparatus are not limited to producing microplates of any particular shape, pattern, quantity, or size. Microplates formed in accordance with the teachings herein may comprise one material, two materials, or more than two materials. Wells may be thermally formed in a variety of shapes, sizes, or patters, on single or on multiple slides. Such microplates may be useful for applications requiring holding or storing of compounds, materials, chemistries, living cells, tissues, RNA/DNA, or other materials and may facilitate storage, screening, and/or testing of such materials for reactions.

Although the invention has been described with reference to preferred embodiments, persons skilled in the art will recognize that changes may be made in form and detail without departing from the spirit and scope of the invention.

1. A method for forming an assembly comprising:
molding a first portion using a primary material;
molding a second portion using a secondary material, wherein the second portion is molded through the first portion and wherein molding the second portion comprises directing the secondary material upwardly such that the second portion is molded from top to bottom.

2. The method of claim 1, further comprising providing at least one chamfer in the first portion and wherein directing the secondary material upwardly is done through the at least one material.

3. The method of claim 1, further comprising providing sufficient secondary material to form a sub-portion of secondary material below at least a portion of the first portion.

4. The method of claim 1, wherein the second portion is molded as a blank.

5. The method of claim 4, further comprising thermally treating the second portion to form wells therein.

6. The method of claim 5, wherein thermally treating the second portion includes inputting specifications for the second portion.

7. The method of claim 1, wherein the second portion is molded with wells formed therein.

8. The method of claim 7, further comprising thermally treating the wells to modify the shape and/or size of the wells.

9. The method of claim 7, further comprising providing a protective covering over the wells.

10. A microplate assembly comprising:
a first portion comprising a primary material that remains substantially rigid after thermal cycling;
a second portion comprising a secondary material suitable for thermal forming, wherein the second portion substantially overlays the first portion; and
additional secondary material underlying at least a portion of the first portion to equalize possible shrinkage of the second portion;
wherein the first portion, the second portion, and the additional secondary material are co-formed.

11. The microplate assembly of claim 10, wherein the primary material is polycarbonate.

12. The microplate assembly of claim 10, wherein the secondary material is polypropylene.

13. The microplate assembly of claim 10, wherein the second portion includes one or more wells formed therein.

14. The microplate assembly of claim 13, wherein each well has a volume of 2 microliters.

15. The microplate assembly of claim 13, wherein each well has a volume of between approximately 0.1 nanoliter and approximatelyl microliter.

16. The microplate assembly of claim 13, wherein each well has a volume of between approximately 1 microliter and approximately 10 microliters.

17. The microplate assembly of claim 13, wherein each well has a volume of between approximately 10 microliters and approximately 100 microliters.

18. The microplate assembly of claim 13, wherein the second portion includes 96 wells.

19. The microplate assembly of claim 13, wherein the second portion includes 384 wells.

20. The microplate assembly of claim 13, wherein the second portion includes 1536 wells.

21. The microplate assembly of claim 10, further comprising a sealing film provided over the one or more wells.

22. The microplate assembly of claim 10, wherein the additional secondary material forms a matrix with the first portion.

23. The microplate assembly of claim 10, wherein the additional secondary material forms a layer under a portion of the first portion.

24. The microplate assembly of claim 10, wherein the first portion has chamfers formed therein.

25. A microplate assembly comprising:
a first portion comprising a polycarbonate material;
a second portion comprises a polypropylene material, the second portion comprising an array of wells, each well having a volume of approximately 2 microliters; and
a sub-portion comprising polypropylene material underlying at least a portion of the first portion to equalize possible shrinkage of the second portion, wherein the first portion and the sub-portion form a matrix;
wherein the first portion, the second portion, and the sub-portion are co-formed.
